(19) United States
(12) Patent Application Publication
(10) Pub. No.: US 2022/0363519 A1
(43) Pub. Date: Nov. 17, 2022

(54) SYSTEMS AND METHODS FOR REMOTE CONTROL AND AUTOMATION OF A TOWER CRANE

(71) Applicant: ULTRAWIS LTD., Be'er Sheva (IL)

(72) Inventors: Lior AVITAN, Kibuz Givat Haim Meuchad (IL); Erez GERNITZY, Atlit (IL); Evgeni GUROVICH, Zichron Yaacov (IL)

(73) Assignee: ULTRAWIS LTD., Be'er Sheva (IL)

(21) Appl. No.: 17/874,398

(22) Filed: Jul. 27, 2022

Related U.S. Application Data
(63) Continuation of application No. PCT/IL2021/050546, filed on May 12, 2021.
(60) Provisional application No. 63/024,729, filed on May 14, 2020.

(51) Int. Cl. B66C 13/40; B66C 23/16; B66C 13/46; B66C 15/06

(52) U.S. Cl. CPC B66C 13/40; B66C 23/16; B66C 13/46; B66C 15/065

(57) ABSTRACT

Systems and methods for remote control and automatization of tower cranes are provided herein. One system may include: a first sensing unit comprising a first image sensor configured to generate a first image sensor dataset; a second sensing unit comprising a second image sensor configured to generate a second image sensor dataset; wherein the first sensing unit and the second sensing unit are adapted to be disposed on a jib of a tower crane at a distance with respect to each other such that a field-of-view of the first sensing unit at least partly overlaps with a field-of-view of the second sensing unit; and a control unit comprising a processing module configured to: determine a real-world geographic location data indicative at least of a real-world geographic location of a hook of the tower crane.

### CROSS-REFERENCE TO RELATED APPLICATIONS

This Application is a continuation of PCT Application No. PCT/IL2021/050546, filed on May 12, 2021, which claims the benefit of U.S. Provisional Patent Application No. 63/024,729 filed on May 14, 2020, which is hereby incorporated by reference in its entirety.

### FIELD OF THE INVENTION

The present invention relates to the field of tower cranes and, more particularly, to systems and methods for remote control and automation of tower cranes.

### BACKGROUND OF THE INVENTION

Tower cranes are widely used in construction sites. Most of the tower cranes are operated by an operator sitting at a cab disposed on a top of the tower crane. Some tower cranes may be operated remotely from the ground.

### SUMMARY OF THE INVENTION

Some embodiments of the present invention may provide a system for a remote control of a tower crane, which system may include: a first sensing unit including a first image sensor configured to generate a first image sensor dataset; a second sensing unit including a second image sensor configured to generate a second image sensor dataset; wherein the first sensing unit and the second sensing unit are adapted to be disposed on a jib of a tower crane at a distance with respect to each other such that a field-of-view of the first sensing unit at least partly overlaps with a field-of-view of the second sensing unit; and a control unit including a processing module configured to: determine a real-world geographic location data indicative at least of a real-world geographic location of a hook of the tower crane based on the first image sensor dataset, the second image sensor dataset, a sensing-units calibration data and the distance between the first sensing unit and the second sensing unit, and control operation of the tower crane at least based on the determined real-world geographic location data.

In some embodiments, the first sensing unit and the second sensing unit are multispectral sensing units each including at least two of: MWIR optical sensor, LWIR optical sensor, SWIR optical sensor, visible range optical sensor, LIDAR sensor, GPS sensor, one or more inertial sensors, anemometer, audio sensor and any combination thereof.

In some embodiments, the processing module is configured to: determine a three-dimensional (3D) model of at least a portion of a construction site based on the first image sensor dataset and the second image sensor dataset, the 3D model including a set of data values that provide a 3D presentation of at least a portion of the construction site, wherein real-world geographic locations of at least some of the data vales of the 3D model are known.

In some embodiments, the processing module is configured to determine the 3D model further based on a LIDAR dataset from at least one of the first sensing unit and the second sensing unit.

In some embodiments, the processing module is configured to: generate a two-dimensional (2D) projection of the 3D model; and display at least one of the generated 2D projection, the first image sensor dataset and the second image sensor dataset on a display.

In some embodiments, the processing module is configured to determine the 2D projection of the 3D model based on at least one of: an operator's inputs received using one or more input devices, a line-of-sight (LOS) of the operator tracked by a LOS tracker, and an external source.

In some embodiments, the processing module is configured to: receive a selection of one or more points of interest made by an operator based on at least one of a 2D projection of the 3D model, the first image sensor dataset and the second image sensor dataset being displayed on a display; and determine a real-world geographic location of the one or more points of interest based on a predetermined display-to-sensing-units coordinate systems transformation, a predetermined sensing-units-to-3D-model coordinate systems transformation and the 3D model.

In some embodiments, the processing module is configured to: receive an origin point of interest in the construction site from which a cargo should be collected and a designation point of interest in the construction site to which the cargo should be delivered; determine real-world geographic locations of the origin point of interest and the destination point of interest based on the 3D model; and determine one or more routes between the origin point of interest and the destination point of interest based on the determined real-world geographic locations and the 3D model.

In some embodiments, the processing module is configured to: generate, based the one or more determined routes, operational instructions to be performed by the tower crane to complete a task; and at least one of: automatically control the tower crane based on the operational instructions and the real-world geographic location data; display at least one of the one or more determined routes and the operational instructions to the operator and control the tower crane based on the operator's input commands.

In some embodiments, the processing module is configured to detect a collision hazard based on the first image sensor dataset, the second image sensor dataset, the determined real-world geographic location data and the 3D model.

In some embodiments, the processing module is configured to: detect an object in the construction site in at least one of the first image sensor dataset and the second image sensor dataset; determine a real-world geographic location of the detected object based on the 3D model; determine whether there is a hazard of collision of at least one component of the tower crane and a cargo with the detected object based on the determined real-world geographic location of the detected object and the determined real-world geographic location data; and at least one of: issue a notification if a hazard of collision is detected; and one of update and change the route upon detection of the collision hazard.

In some embodiments, the one or more points of interest including a safety zone to which a cargo being carried by the tower crane should be delivered in the case of failure of the system.

In some embodiments, the system includes: an aerial platform configured to navigate in at least a portion of the construction site and generate aerial platform data values providing a 3D presentation of at least a portion of a construction site; and the processing module is configured to update the 3D model based on at least a portion of the aerial platform data values.

In some embodiments, the processing module is: in communication with a database of preceding 3D models of the construction site or a portion thereof; and configured to: compare the determined 3D model with at least one of the preceding 3D models; and present the comparison results indicative of a construction progress made to at least one of the operator and an authorized third party.

In some embodiments, the processing module is configured to: generate a 2D graphics with respect to a display coordinate system; and enhance at least one of the first image sensor data, the second image sensor data and a 2D projection of a 3D model being displayed on the display with the 2D graphics.

In some embodiments, the 2D graphics includes visual presentation of at least one of: a jib of the tower crane, trolley position along the jib and jib's stoppers, an angular velocity of the jib, a jib direction with respect to North, a wind direction with respect to North, status of one or more input devices of the system, height of a hook above a ground, a relative panorama viewpoint, statistical process control, an operator card, a task bar and any combination thereof.

In some embodiments, the processing module is configured to: generate a 3D graphics with respect to a real-world coordinate system; and enhance at least one of the first image sensor data, the second image sensor data and a 2D projection of the 3D model being displayed on the display with the 3D graphics.

In some embodiments, the 3D graphics includes visual presentation of at least one of: different zones in the construction site, weight zones, a tower crane maximal cylinder zone, a tower crane cylinder zone overlap with a tower crane cylinder zone of another crane, current cargo position and cargo drop position, a lift to drop route, a specified person on in the construction site, at least one of moving elements, velocity and estimated routes thereof, at least one of bulk material and the estimated amount thereof, hook turn direction, safety alerts and any combination thereof.

In some embodiments, the processing module is configured to determine the sensing-units calibration data indicative of real-world orientations of the first sensing unit and the second sensing unit by: detecting three or more objects in the first image sensor dataset; detecting the three or more objects in the second image sensor dataset; determining, based on a virtual model of the first image sensor, three or more first vectors in a first image sensor coordinate system, each of the first vectors extending between the first image sensor and one of the three or more detected objects; determining, based on a virtual model of the second image sensor, three or more second vectors in a second sensor coordinate system, each of the second vectors extending between the second image sensor and one of the three or more detected objects; determining an image sensors position vector extending between the first image sensor and the second image sensor in the first image sensor coordinate system and an orientation of the second image sensor with respect to the first image sensor in the first image sensor coordinate system based on the three or more first vectors and the three or more second vectors; obtaining a first real-world geographic location of the first image sensor in the real-world coordinate system; obtaining a second real-world geographic location of the second image sensor in the real-world coordinate system; determining a real-world orientation of the first image sensor in the real-world coordinate system based on the determined image sensors position vector, the obtained first real-world location of the first image sensor and the obtained second real-world location of the second image sensor; and determining a real-world orientation of the second image sensor in the real-world coordinate system based on the determined real-world orientation of the first image sensor and the determined orientation of the second image sensor with respect to the first image sensor.

In some embodiments, the processing module is configured to perform a built-in-test to detect misalignment between the first sensing unit and the second sensing unit by: detecting an object in the first image sensor dataset and detecting the object in the second image dataset; and determining whether a misalignment between the first image sensor and the second image sensor is above a predetermined threshold based on the detections and the sensing-units calibration data.

Some embodiments of the present invention may provide a method of a remote control of a tower crane, the method may include: obtaining a first image sensor dataset by a first image sensor a first sensing unit; obtaining a second image sensor dataset by a second image sensor of a second sensing unit; wherein the first sensing unit and the second sensing unit are disposed on a jib of a tower crane at a distance with respect to each other such that a field-of-view of the first sensing unit at least partly overlaps with a field-of-view of the second sensing unit; determining, by a processing module, a real-world geographic location data indicative at least of a real-world geographic location of a hook of the tower crane based on the first image sensor dataset, the second image sensor dataset, a sensing-units calibration data and the distance between the first sensing unit and the second sensing unit; and controlling, by the processing module, operation of the tower crane at least based on the determined real-world geographic location data.

In some embodiments, the first sensing unit and the second sensing unit are multispectral sensing units each including at least two of: MWIR optical sensor, LWIR optical sensor, SWIR optical sensor, visible range optical sensor, LIDAR sensor, GPS sensor, one or more inertial sensors, anemometer, audio sensor and any combination thereof.

In some embodiments, the method may include: determining a three-dimensional (3D) model of at least a portion of a construction site based on the first image sensor dataset and the second image sensor dataset, the 3D model including a set of data values that provide a 3D presentation of at least a portion of the construction site, wherein real-world geographic locations of at least some of the data vales of the 3D model are known.

In some embodiments, the method may include determining the 3D model further based on a LIDAR dataset from at least one of the first sensing unit and the second sensing unit.

In some embodiments, the method may include: generating a two-dimensional (2D) projection of the 3D model; and displaying at least one of the generated 2D projection, the first image sensor dataset and the second image sensor dataset on a display.

In some embodiments, the method may include determining the 2D projection of the 3D model based on at least one of: an operator's inputs received using one or more input devices, a line-of-sight (LOS) of the operator tracked by a LOS tracker, and an external source.

In some embodiments, the method may include: receiving a selection of one or more points of interest made by an operator based on at least one of a 2D projection of the 3D model, the first image sensor dataset and the second image sensor dataset being displayed on a display; and determining a real-world geographic location of the one or more points of interest based on a predetermined display-to-sensing-units coordinate systems transformation, a predetermined sensing-units-to-3D-model coordinate systems transformation and the 3D model.

In some embodiments, the method may include: receiving an origin point of interest in the construction site from which a cargo should be collected and a designation point of interest in the construction site to which the cargo should be delivered; determining real-world geographic locations of the origin point of interest and the destination point of interest based on the 3D model; and determining one or more routes between the origin point of interest and the destination point of interest based on the determined real-world geographic locations and the 3D model.

In some embodiments, the method may include: generating, based the one or more determined routes, operational instructions to be performed by the tower crane to complete a task; and at least one of: automatically controlling the tower crane based on the operational instructions and the real-world geographic location data; and displaying at least one of the one or more determined routes and the operational instructions to the operator and control the tower crane based on the operator's input commands.

In some embodiments, the method may include detecting a collision hazard based on the first image sensor dataset, the second image sensor dataset, the determined real-world geographic location data and the 3D model.

In some embodiments, the method may include: detecting an object in the construction site in at least one of the first image sensor dataset and the second image sensor dataset; determining a real-world geographic location of the detected object based on the 3D model; determining whether there is a hazard of collision of at least one component of the tower crane and a cargo with the detected object based on the determined real-world geographic location of the detected object and the determined real-world geographic location data; and at least one of: issuing a notification if a hazard of collision is detected; and one of updating and changing the route upon detection of the collision hazard.

In some embodiments, the one or more points of interest including a safety zone to which a cargo being carried by the tower crane should be delivered in the case of failure of the system.

In some embodiments, the method may include: generating aerial platform data values by an aerial platform configured to navigate in at least a portion of the construction site, the aerial platform data values providing a 3D presentation of at least a portion of a construction site; and updating the 3D model based on at least a portion of the aerial platform data values.

In some embodiments, the method may include: comparing the determined 3D model with at least one preceding 3D model; and presenting the comparison results indicative of a construction progress made to at least one of the operator and an authorized third party.

In some embodiments, the method may include: generating a 2D graphics with respect to a display coordinate system; and enhancing at least one of the first image sensor data, the second image sensor data and a 2D projection of a 3D model being displayed on the display with the 2D graphics.

In some embodiments, the 2D graphics includes visual presentation of at least one of: a jib of the tower crane, trolley position along the jib and jib's stoppers, an angular velocity of the jib, a jib direction with respect to North, a wind direction with respect to North, status of one or more input devices of the system, height of a hook above a ground, a relative panorama viewpoint, statistical process control, an operator card, a task bar and any combination thereof.

In some embodiments, the method may include: generating a 3D graphics with respect to a real-world coordinate system; and enhancing at least one of the first image sensor data, the second image sensor data and a 2D projection of the 3D model being displayed on the display with the 3D graphics.

In some embodiments, the 3D graphics includes visual presentation of at least one of: different zones in the construction site, weight zones, a tower crane maximal cylinder zone, a tower crane cylinder zone overlap with a tower crane cylinder zone of another crane, current cargo position and cargo drop position, a lift to drop route, a specified person on in the construction site, at least one of moving elements, velocity and estimated routes thereof, at least one of bulk material and the estimated amount thereof, hook turn direction, safety alerts and any combination thereof.

In some embodiments, the method may include determining the sensing-units calibration data indicative of real-world orientations of the first sensing unit and the second sensing unit by: detecting three or more objects in the first image sensor dataset; detecting the three or more objects in the second image sensor dataset; determining, based on a virtual model of the first image sensor, three or more first vectors in a first image sensor coordinate system, each of the first vectors extending between the first image sensor and one of the three or more detected objects; determining, based on a virtual model of the second image sensor, three or more second vectors in a second sensor coordinate system, each of the second vectors extending between the second image sensor and one of the three or more detected objects; determining an image sensors position vector extending between the first image sensor and the second image sensor in the first image sensor coordinate system and an orientation of the second image sensor with respect to the first image sensor in the first image sensor coordinate system based on the three or more first vectors and the three or more second vectors; obtaining a first real-world geographic location of the first image sensor in the real-world coordinate system; obtaining a second real-world geographic location of the second image sensor in the real-world coordinate system; determining a real-world orientation of the first image sensor in the real-world coordinate system based on the determined image sensors position vector, the obtained first real-world location of the first image sensor and the obtained second real-world location of the second image sensor; and determining a real-world orientation of the second image sensor in the real-world coordinate system based on the determined real-world orientation of the first image sensor and the determined orientation of the second image sensor with respect to the first image sensor.

In some embodiments, the method may include: performing a built-in-test to detect misalignment between the first sensing unit and the second sensing unit by: detecting an object in the first image sensor dataset and detecting the object in the second image dataset; and determining whether a misalignment between the first image sensor and the second image sensor is above a predetermined threshold based on the detections and the sensing-units calibration data.

Some embodiments of the present invention may provide a method of determining real-world orientations of two or more image sensors, which method may include: obtaining a first image sensor dataset by a first image sensor and obtaining a second image dataset by a second image sensor, wherein fields-of-view of the first image sensor and of the second image sensor at least partly overlap with each other; detecting three or more objects in the first image sensor dataset; detecting the three or more objects in the second image sensor dataset; determining, based on a virtual model of the first image sensor, three or more first vectors in a first image sensor coordinate system, each of the first vectors extending between the first image sensor and one of the three or more detected objects; determining, based on a virtual model of the second image sensor, three or more second vectors in a second sensor coordinate system, each of the second vectors extending between the second image sensor and one of the three or more detected objects; determining an image sensors position vector extending between the first image sensor and the second image sensor in the first image sensor coordinate system and an orientation of the second image sensor with respect to the first image sensor in the first image sensor coordinate system based on the three or more first vectors and the three or more second vectors; obtaining a first real-world geographic location of the first image sensor in the real-world coordinate system; obtaining a second real-world geographic location of the second image sensor in the real-world coordinate system; determining a real-world orientation of the first image sensor in the real-world coordinate system based on the determined image sensors position vector, the obtained first real-world location of the first image sensor and the obtained second real-world location of the second image sensor; and determining a real-world orientation of the second image sensor in the real-world coordinate system based on the determined real-world orientation of the first image sensor and the determined orientation of the second image sensor with respect to the first image sensor.

Some embodiments of the present invention may provide a method of determining a misalignment between two or more image sensors, the method may include: obtaining a first image sensor dataset by a first image sensor and obtaining a second image dataset by a second image sensor, wherein fields-of-view of the first image sensor and of the second image sensor at least partly overlap with each other; detecting an object in the first image sensor dataset and detecting the object in the second image dataset; and determining whether a misalignment between the first image sensor and the second image sensor is above a predetermined threshold based on the detections and an image sensors calibration data.

Some embodiments of the present invention may provide a method of determining a real-world geographic location of at least one object, the method may include: obtaining a first image sensor dataset by a first image sensor and obtaining a second image dataset by a second image sensor, wherein fields-of-view of the first image sensor and of the second image sensor at least partly overlap with each other; detecting a specified object in the first image sensor dataset and detecting the specified object in the second image sensor dataset; determining an azimuth and an elevation of the specified object in a real-world coordinate system based on the detections and an image sensors calibration data; and determining a real-world geographic location of the specified object based on the determined azimuth and elevation and a distance between the first image sensor and the second image sensor.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIG. 1 is a schematic illustration of a system for remote control of a tower crane and of a tower crane, according to some embodiments of the invention;

FIG. 2 is a schematic block diagram of a more detailed aspect of a system for remote control of a tower crane, according to some embodiments of the invention;

FIG. 3 is a flowchart of a method of a remote operation of a tower crane performed by a system for remote operation of the tower crane, according to some embodiments of the invention;

FIG. 4A is a flowchart of a method of determining real-world orientations of two or more image sensors in a real-world coordinate system based on image datasets obtained by the image sensors thereof, according to some embodiments of the invention;

FIG. 4B depicts an example of determining real-world orientations of two or more image sensors in a real-world coordinate system based on image datasets obtained by the image sensors thereof, according to some embodiments of the invention;

FIG. 5 is a flowchart of a method of determining a misalignment between two or more image sensors, according to some embodiments of the invention;

FIG. 6 is a flowchart of a method of determining a real-world geographic location of at least one object based on image datasets obtained by two image sensors, according to some embodiments of the invention;

FIGS. 7A-7I depict examples of a two-dimensional (2D) graphics for enhancing an image of a construction site being displayed on a display of a system for remote operation of a tower crane, according to some embodiments of the invention;

FIGS. 7J and 7K depict examples of images of a construction site being displayed on a display of a system for remote operation of a tower crane, wherein the images are enhanced with at least some of the 2D graphics of FIGS. 7A-7I, according to some embodiments of the invention;

FIGS. 8A-8L depict examples of a three-dimensional (3D) graphics for enhancing an image of a construction site being displayed on a display of a system for remote operation of a tower crane, according to some embodiments of the invention;

FIG. 9 is a flow chart of a method of a remote control of a tower crane, according to some embodiments of the invention;

FIGS. 10A-10K depict various diagrams illustrating collision detection and avoiding when two or more cranes are positioner in close proximity to each other according to some embodiments of the invention; and

FIGS. 11A-11D depict diagrams illustrating operator symbology used in embodiments in accordance with the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units can be at least partially implemented by a computer processor.

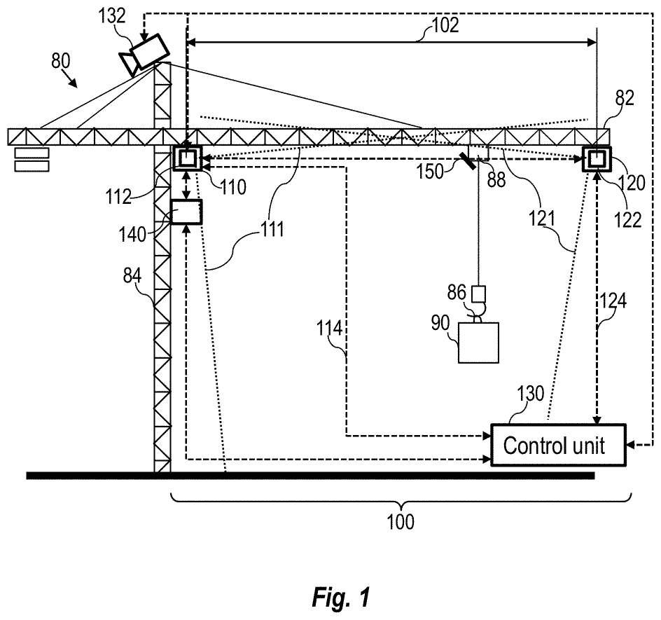

Reference is now made to FIG. 1, which is a schematic illustration of a system 100 for remote control of a tower crane 80 and of a tower crane 80, according to some embodiments of the invention.

According to some embodiments, system 100 may include a first sensing unit 110, a second sensing unit 120, a control unit 130 and a tower crane control interface 140.

First sensing unit 110 and second sensing unit 120 may be adapted to be disposed on a jib 82 of tower crane 80 at a predetermined distance 102 with respect to each other such that a field-of-view (FOV) 111 of first sensing unit 110 at least partly overlaps with a FOV 121 of second sensing unit 120. For example, first sensing unit 110 may be disposed at a mast 84 of tower crane 80 and second sensing unit 120 may be disposed at a distal end of jib 82 thereof, e.g., as shown in FIG. 1.

First sensing unit 110 may include at least one first image sensor 112. First image sensor(s) 112 may generate a first image sensor dataset 114 indicative of an image of at least a portion of a construction site. Second sensing unit 120 may include at least one second image sensor 122. Second image sensor(s) 122 may generate a second image sensor dataset 124 indicative of an image of at least a portion of the construction site.

Control unit 130 may be disposed on, for example, the ground. First sensing unit 110 and second sensing unit 120 may be in communication with control unit 130. In various embodiments, the communication may be wired and/or wireless. In some embodiments, the communication may be bidirectional.

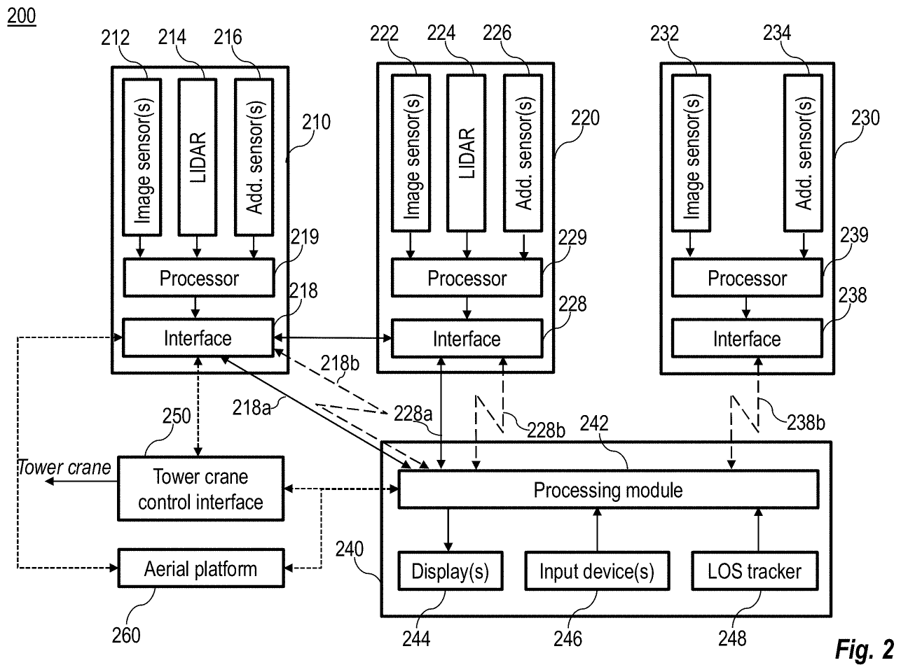

Control unit 130 may receive first image sensor dataset 114 and second image sensor dataset 124. Control unit 130 may determine a real-world geographic location of a hook 86 of tower crane 80 and/or of a cargo 90 attached thereto based on first image sensor dataset 114, second image sensor dataset 124, sensing-units calibration data and predetermined distance 102 between first sensing unit 110 and second sensing unit 120 (e.g., as described below with respect to FIG. 2).

Control unit 130 may control tower crane 80 via tower crane control interface 140 based on the determined real-world geographic location of hook 86/cargo 90. In various embodiments, control unit 130 may automatically control tower crane 80 or control tower crane 80 based on operator's control inputs. In some embodiments, first sensing unit 110 may be in communication (e.g., wired or wireless) with tower crane control interface 140 and control unit 130 may control tower crane 80 via first sensing unit 110. In some embodiments, first sensing unit 110 and second sensing unit 120 may be in communication with each other.

In some embodiments, system 100 may include an additional image sensor 132. Additional sensor 132 may be adapted to be disposed on tower crane 80 and adapted to capture images of, for example, motors of tower crane 80 and/or a proximal portion thereof. In various embodiments, additional image sensor 132 may be in communication (e.g., wired or wireless) with first sensing unit 110 or control unit 130. Control unit 130 may be configured to receive images from additional image sensor 132 (e.g., either directly or via first sensing unit 110). Control unit 130 may be configured to generate data concerning, for example, a state and/or position of the motors of tower crane 80 based on the images from additional image sensor 132.

In some embodiments, system 100 may include a mirror 150. Mirror 150 may be connected to a trolley 88 of tower crane 80, for example at an angle of 45° with respect to jib 82 thereof. In this manner, first image dataset 114 may include an image of hook 68 of tower crane 86 as observed in mirror 150.

It is noted that, although the systems described herein relate to systems for remote control of tower cranes, the systems may be also utilized for remote control of another heavy equipment such as mobile cranes, excavators, etc.

Reference is also made to FIG. 2, which is a schematic block diagram of a more detailed aspect of a system 200 for remote control of a tower crane, according to some embodiments of the invention.

According to some embodiments, system 200 may include a first sensing unit 210, a second sensing unit 220, a hook sensor 230 and a control unit 240.

First sensing unit 210 and second sensing unit 220 may be adapted to be disposed on a jib of a tower crane at a predetermined sensing-units distance with respect to each other such that a field-of-view (FOV) of first sensing unit 210 at least partly overlaps with a FOV of second sensing unit 220. For example, first sensing unit 210 may be disposed at a mast of the tower crane and second sensing unit 220 may be disposed at an end of the jib thereof (e.g., such as first sensing unit 110 and second sensing unit 120 described above with respect to FIG. 1).

First sensing unit 210 may include at least one first image sensor 210. In some embodiments, first sensing unit 210 may include two or more multispectral image sensors 212. For example, image sensors 210 may include sensor in MWIR, LWIR, SWIR, visible range, etc. In some embodiments, first sensing unit 210 may include a first LIDAR 214. In some embodiments, first sensing unit 210 may include at least one additional sensor 216. Additional sensor(s) 216 may include at least one of GPS sensor, one or more inertial sensors, anemometer, audio sensor. In some embodiments, first sensing unit 210 may include a power supply for supplying power to components of first sensing unit 210.

First sensing unit 210 may include a first sensing unit interface 218. First sensing unit interface 218 may collect data from sensors of first sensing unit 210 in a synchronized manner to provide a first sensing unit dataset and to transmit the first sensing unit dataset to control unit 240. The first sensing unit dataset may include at least one of: first image sensor dataset, first LIDAR dataset and first additional sensor dataset. In various embodiments, first sensing unit 210 may be in wired communication 218a (e.g., optical fiber) and/or wireless communication 218b (e.g., WiFi) with control unit 240. In some embodiments, first sensing unit 210 may include a first sensing unit processor 219. First sensing unit processor 219 may process and/or preprocess at least a portion of the first sensing unit dataset.

Second sensing unit 220 may include at least one second image sensor 220. In some embodiments, second sensing unit 220 may include two or more multispectral image sensors 222. For example, image sensors 220 may include sensor in MWIR, LWIR, SWIR, visible range, etc. In some embodiments, second sensing unit 220 may include a second LIDAR 224. In some embodiments, second sensing unit 220 may include at least one additional sensor 226. Additional sensor(s) 226 may include at least one of GPS sensor, one or more inertial sensors, anemometer, audio sensor. In some embodiments, second sensing unit 220 may include a power supply for supplying power to components of second sensing unit 220.

Second sensing unit 220 may include a second sensing unit interface 228. Second sensing unit interface 228 may collect data from sensors of second sensing unit 220 in a synchronized manner to provide a second sensing unit dataset and to transmit the second sensing unit dataset to control unit 240. The second sensing unit dataset may include at least one of: second image sensor dataset, second LIDAR dataset and second additional sensor dataset. In various embodiments, second sensing unit 220 may be in wired communication 228a (e.g., optical fiber) and/or wireless communication 228b (e.g., WiFi) with control unit 240. In some embodiments, second sensing unit 220 may include a second sensing unit processor 229. Second sensing unit processor 229 may process and/or preprocess at least a portion of the second sensing unit dataset.

In some embodiments, first sensing unit 210 may be in communication (e.g., wired or wireless) with second sensing unit 220. First sensing unit 210 and second sensing unit 220 may exchange therebetween at least a portion of the first sensing unit dataset and at least a portion of the second sensing unit dataset.

In some embodiments, system 200 may include a hook sensing unit 230. Hook sensing unit 230 may be adapted or configured to be disposed on a hook of the tower crane. Hook sensing unit 230 may include at least one image sensor 232. In some embodiments, hook sensing unit 230 may include at least one additional sensor 234. Additional sensor(s) 234 may include at least one of GPS sensor, one or more inertial sensors, audio sensor, RFID reader, etc. Hook sensing unit 230 may include a hook sensing unit interface 238. Hook sensing unit interface 238 may collect data from sensors of hook sensing unit 230 in a synchronized manner to provide a hook sensing unit dataset and to transmit the hook sensing unit dataset to control unit 240. The communication 228a between hook sensing unit 220 and control unit 240 may be wireless. The hook sensing unit dataset may include at least one of: hook image sensor dataset and hook additional sensor dataset. In some embodiments, hook sensing unit 230 may include a hook sensing unit processor 239. Hook sensing unit processor 219 may process and/or preprocess at least a portion of the hook sensing unit dataset.

Control unit 240 may be disposed, for example, on the ground. Control unit 240 may include at least one of processing module 242, one or more displays 244, one or more input devices 246 (e.g., one or more joysticks, keyboards, camera, operator's card reader, etc.) and a line of sight (LOS) tracker 248. In some embodiments, control unit 240 may include speakers (e.g., for playing notifications, alerts, etc.).

Processing module 242 may receive the first sensing unit dataset from first sensing unit 210 and the second sensing unit dataset from the second sensing unit 220.

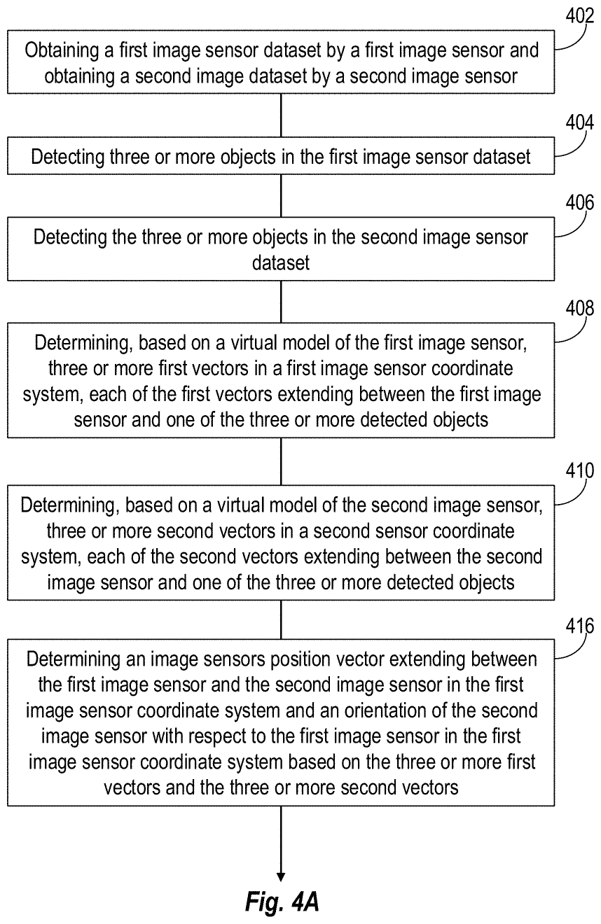

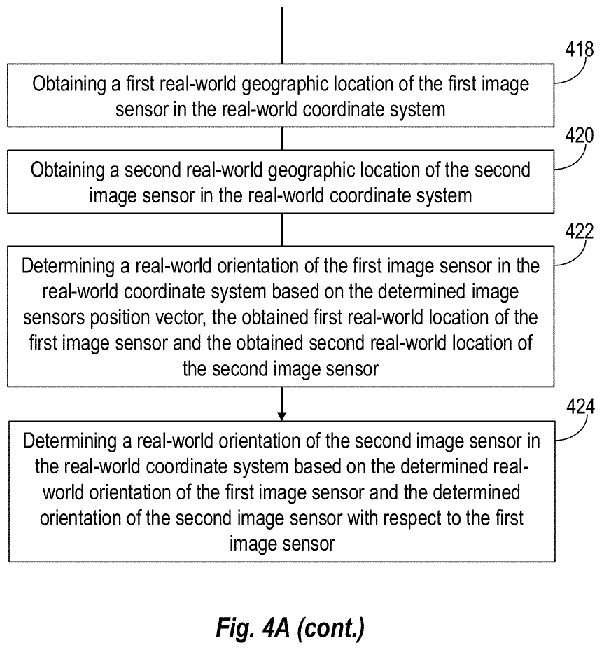

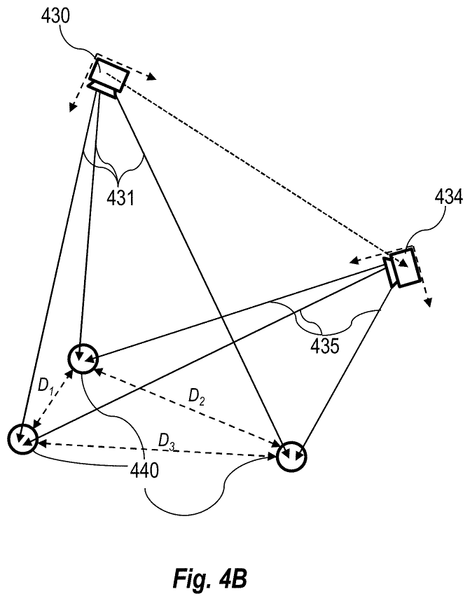

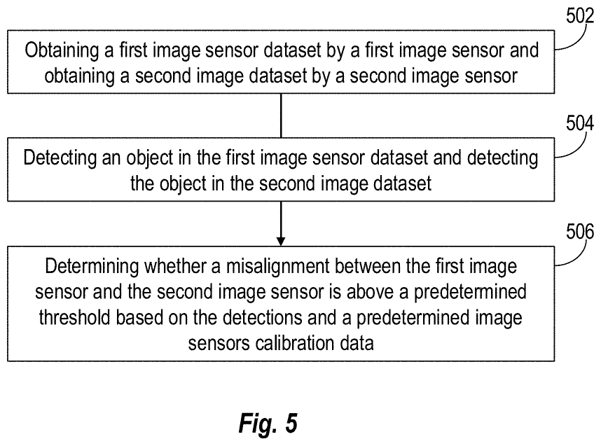

In some embodiments, processing module 242 may generate a sensing-units calibration data based on the first image sensor dataset (obtained by first image sensor(s) 212 of first sensing unit 210) and the second image sensor dataset (obtained by second image sensor(s) 222 of second sensing unit 220). The sensing-units calibration data may include at least a real-world orientation of first sensing unit 210 and a real-world orientation of second sensing unit 220 in a real-world coordinate system. One example of generating the sensing-units calibration data is described below with respect to FIGS. 4A and 4B. In some embodiments, processing module 242 may periodically update the sensing-units calibration data. In some embodiments, processing module 242 may perform a built-in-test to detect misalignment between first sensing unit 210 and second sensing unit 220 (e.g., as described below with respect to FIG. 5). Processing module 242 may, for example, update the sensing-units calibration data upon detection of the misalignment.

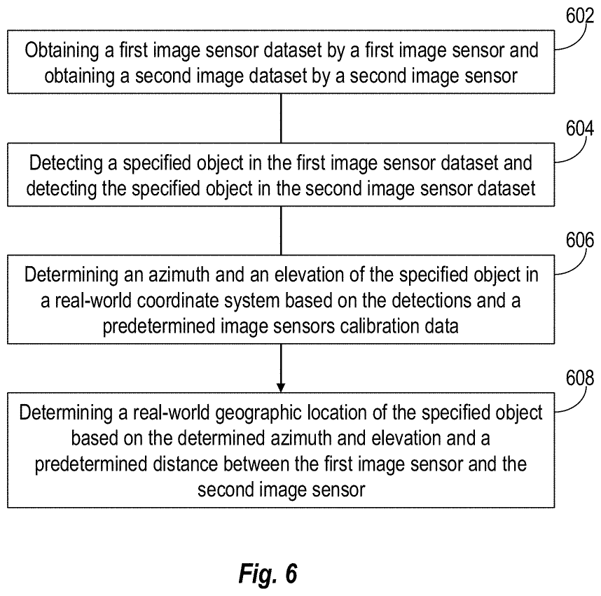

In some embodiments, processing module 242 may determine a real-world geographic location data based on the first image sensor dataset, the second image sensor dataset, the sensing-units calibration data and the predetermined sensing-units distance. The real-world geographic location data may include a real-world geographic location of at least one component of the tower crane such as, for example, the hook and/or the cargo carried thereon, a position of a trolley of the tower crane along the jib thereof, an angle of the jib with respect to North, etc. One example of determining the tower crane real-world geographical location data is described below with respect to FIG. 6.

In some embodiments, processing module 242 may determine tower crane kinematic parameters. For example, processing module 242 may determine the tower crane kinematic parameters based on one or more of at least a portion of the first additional sensor dataset and at least a portion of the second additional sensor dataset. The tower crane kinematic parameters may include, for example, a velocity of jib 82, an acceleration of jib 82, a direction of movement of jib 82, etc.

In some embodiments, processing module 242 may determine a three-dimensional (3D) model of at least a portion of the construction site based on the first image sensor dataset and the second image sensor dataset. The 3D model may include a set of data values that provide a 3D presentation of at least a portion of the construction site. For example, processing module 242 may determine a first sub-set of data values based on the first image sensor dataset, a second sub-set of data values based on the second image sensor dataset and combine at least a portion of the first sub-set and at least a portion of the second sub-set of data values to provide the set of data values that provide the 3D representation of at least a portion of the construction site. Real-world geographic locations of at least some of the data vales of the 3D model may be known and/or determined by processing module 242 (e.g., using SLAM methods, etc.). In some embodiments, the 3D model may be scaled with respect to the real-world coordinate system. The scaling may be done based on the first image sensor dataset, the second image sensor dataset the sensing-units calibration data and predetermined sensing-units distance.

In some embodiments, processing module 242 may determine the 3D model further based on at least one of a first LIDAR dataset from first LIDAR 214 of first sensing unit 210 and a second LIDAR dataset from second LIDAR 224 of second sensing unit 220. For example, processing module 242 may combine at least a portion of the first image sensor dataset, at least a portion of the second image sensor dataset, at least a portion of the first LIDAR dataset and at least a portion of the second LIDAR dataset to generate the 3D model. The combination may be based on, for example, the quality of each dataset. For example, if the first LIDAR dataset has reduced quality its data values may be assigned with a lower weight when combined into the 3D model as compared to weight of other datasets.

In some embodiments, processing module 242 may determine a textured 3D model based on the first image sensor dataset, the second image sensor dataset and the 3D model. For example, processing module 242 may perform texture mapping on the 3D model to provide the textured 3D model.

In various embodiments, processing module 242 may periodically determine and/or update the 3D model. For example, processing module 242 may determine the 3D model at a beginning of each working day. In another example, processing module 242 may determine two or more 3D models during the same working day and/or update at least one of the determined 3D models one or more times during the working day. The frequency of the determination and/or the update of the 3D model(s) may be predetermined or selected by the operator of system 200, for example according to progress of construction, and/or according to specified parameters of system 200.

In some embodiments, processing module 242 may generate a two-dimensional (2D) projection of the 3D model/textured 3D model. The 2D projection of the 3D model/textured 3D model may be generated based on operator's input via input device(s) 246, based on a LOS of the operator tracked by LOS tracker 248 or an external source. For example, the operator may select a desired direction of view using input device(s) 246 (e.g., joysticks, etc.) or by gazing in the desired direction of view. In some embodiments, processing module 242 may display at least one of the generated 2D projection of the 3D model/textured 3D model, the first image sensor dataset and the second image sensor dataset on display(s) 244.

In some embodiments, processing module 242 may receive one or more points of interest from the operator and may determine real-world geographic location of the point(s) of interest in the real-world coordinate system. For example, the point(s) of interest may be selected by the operator via input device(s) 246 based on at least one of the generated 2D projection of the 3D model/textured 3D model, the first image sensor dataset and the second image sensor dataset being displayed on display(s) 244. In some embodiments, processing module 242 may determine real-world geographic location(s) of the point(s) of interest based on a predetermined display-to-sensing-units coordinate systems transformation, a predetermined sensing-units-to-3D-model coordinate systems transformation and the 3D model.

One example of points of interest may include an origin point in the construction site from which a cargo should be collected and a designation point in the construction site to which the cargo should be delivered. The origin point and the designation point may be selected by the operator via input device(s) 246 based on at least one of the generated 2D projection of the 3D model/textured 3D model, the first image sensor dataset and the second image sensor dataset being displayed on display(s) 244. Processing module 242 may determine real-world geographic locations of the origin point and the designation points based on the predetermined display-to-sensing-units coordinate systems transformation, the predetermined sensing-units-to-3D-model coordinate systems transformation and the 3D model.

In some embodiments, processing module 242 may receive the origin point and the designation point, determine the real-world geographic locations of the origin points and the designation points and determine one or more routes for delivering the cargo between the origin point and the designation point by the tower crane based on the 3D model. The route(s) may include, for example, a set of actions to be performed by the tower crane in order to deliver the cargo from the origin point to the designation point. In some embodiments, processing module 242 may select an optimal route of the one or more determined route(s). The optimal route may be, for example, the shortest and/or fastest and/or safest route of the determined one or more routes. In various embodiments, processing module 242 may present the one or more determined route(s) and/or the optimal route thereof on display(s) 244.

Processing module 242 may be in communication with tower control interface 250. In some embodiments, processing unit module 242 may be in direct communication with tower control interface 250. In some embodiments, processing module 242 may communicate with tower control interface 250 via first sensing unit 210.

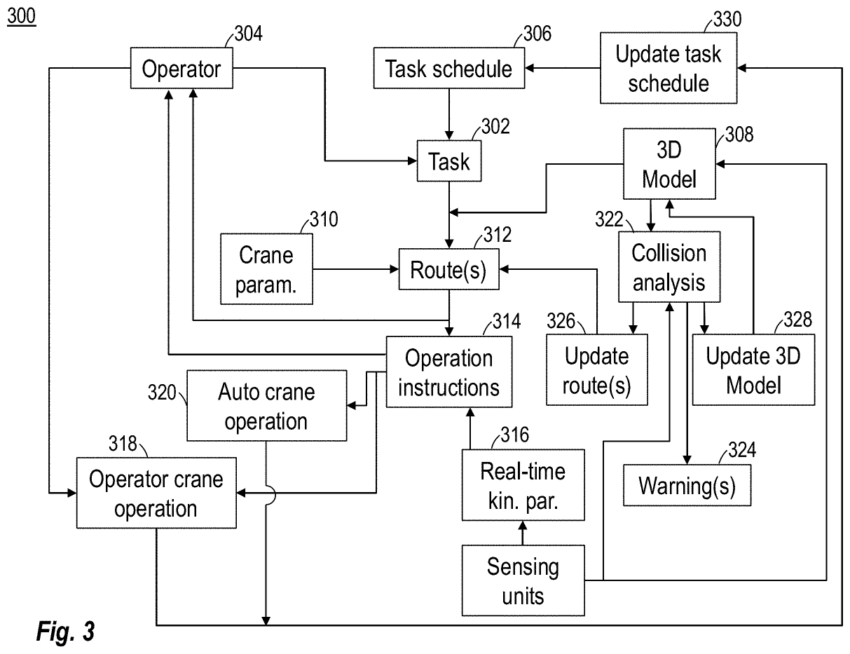

Processing module 242 may control the tower crane via tower control interface 250 (e.g., either directly or via first sensing unit 210). In some embodiments, processing module 242 may control the tower crane based on operation commands provided by the operator via input device(s) 246 (e.g., according to one of the determined route(s)). For example, processing module 242 may generate operational instructions based on the determined route(s), the operational instructions may include functions to be performed by the tower crane to complete a task (e.g., to deliver the cargo from the origin point of the destination point). Processing module 242 may display the route(s) and/or the operational instructions to the operator on display(s) 244 that may provide operational input commands to processing module 242 via input device(s) 246. In some embodiments, processing module 242 may automatically control the tower crane based on one of the determined route(s) (e.g., a route selected by the user or optimal route) and the determined real-world geographic location data. For example, processing module 242 may automatically control the tower crane based on the determined operational instructions. One example of operation of the tower crane is described below with respect to FIG. 3.

In some embodiments, processing module 242 may be in communication (e.g., wired or wireless) with one or more external systems. Processing module 242 and the external system(s) may exchange data therebetween. Such external systems may include, for example, a cloud (e.g., for saving and/or processing data), automated platforms (e.g., aerial and/or heavy machinery in the construction site), etc. For example, processing module 242 may send the 3D model to the automated platforms in the construction site.

In some embodiments, processing module 242 may detect a collision hazard based on the first image sensor dataset, the second image sensor dataset, the determined real-world geographic location data and the 3D model. For example, processing module 242 may detect an object in the construction site in at least one of the first image sensor dataset and the second image sensor dataset. Processing module 242 may determine a real-world geographic location of the detected object based on the 3D model. Processing module 242 may determine whether there is a hazard of collision of at least one component of the tower crane/cargo with the detected object based on the determined real-world geographic location of the detected object and the determined real-world geographic location data. Processing module 242 may issue a notification if a hazard of collision is detected. For example, processing module 242 may display a visual notification on display(s) 244. Some other examples of notifications may include audio notifications and/or vibrational notifications. In some embodiments, processing module 242 may terminate the operation of the tower crane upon detection of the collision hazard. In various embodiments, processing module 242 may update or change the route upon detection of the collision hazard.

In some embodiments, the operator of system 200 may define a safety zone in the construction site. The safety zone may be, for example, a zone to which the cargo being carried by the tower crane should be delivered, for example in the case of failure of system 200. The safety zone may be, for example, selected by the operator using input device(s) 246 based on at least one of the first image sensor dataset, the second image sensor dataset and the 2D projection of the 3D model/textured 3D model being displayed on display(s) 244. In some embodiments, processing module 242 may determine a real-world geographic location of the safety zone (e.g., based on the predetermined display-to-sensing-units coordinate systems transformation, the predetermined sensing-units-to-3D-model coordinate systems transformation and the 3D model). Processing module 242 may determine an optimal route (e.g., fastest and/or shortest and/or safest route) to the safety zone based on the determined real-world geographic location of the safety zone, the determined real-world geographic location data and the 3D model.

In some embodiments, system 200 may include an aerial platform 260 (e.g., a drone). In various embodiments, aerial platform 260 may be controlled by processing module 242, by first sensing unit processor 219 and/or by the operator of system 200. Upon request, aerial platform 260 may navigate in at least a portion of the construction site and generate aerial platform data values providing a 3D presentation of at least a portion of a construction site. Aerial platform 260 may transmit the aerial platform data values to processing module 242. Processing module 242 may update the 3D model based on at least a portion of the aerial platform data values. This may, for example, enable completing missing parts in the 3D model, provide additional points view of the construction site, observe state and/or condition of tower crane 80, etc. In some embodiments, system 200 may include an aerial platform accommodating site (e.g., on tower crane 80) at which aerial platform may be charged and/or exchange data with processing module 242 and/or first sensing unit processor 219.

In various embodiments, control unit 240 may include or may be in communication with a database of preceding 3D models of the construction site or a portion thereof. Processing module 242 may compare the determined 3D model with at least one of the preceding 3D models. Processing module 242 may present the comparison results indicative of a construction progress made to the operator or an authorized third party (e.g., a construction site manager).

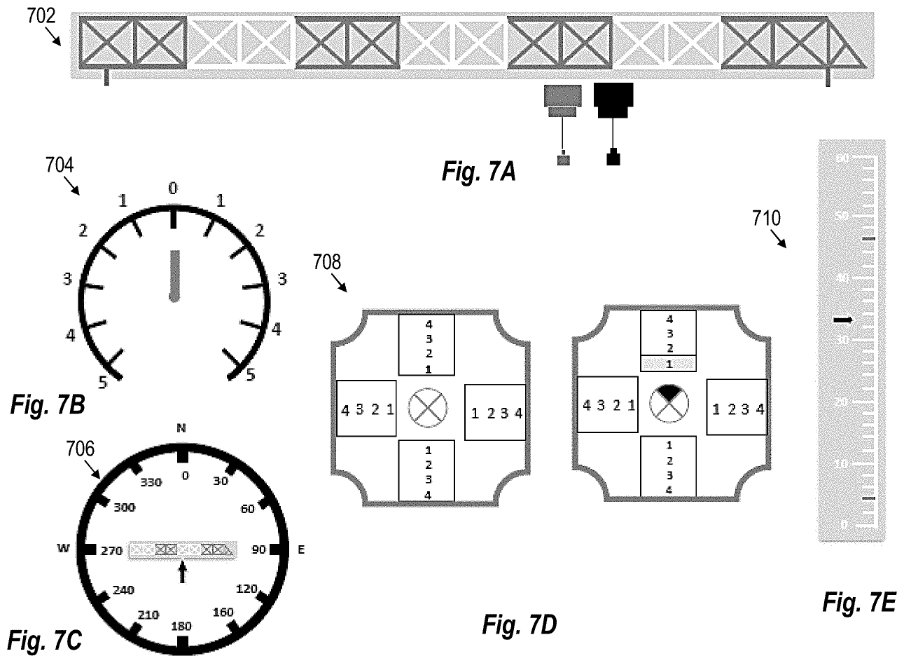

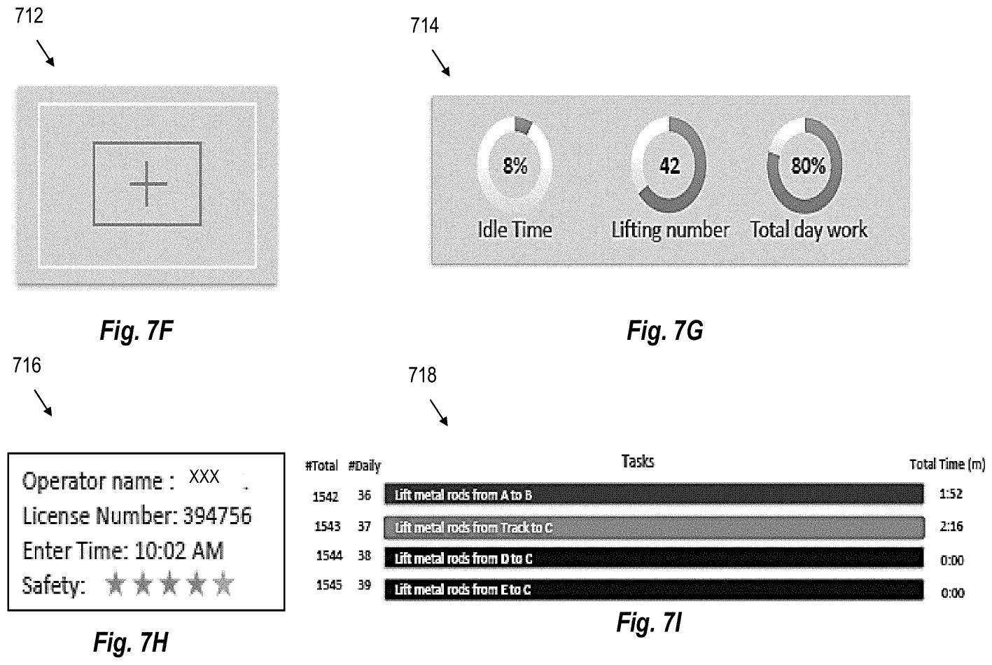

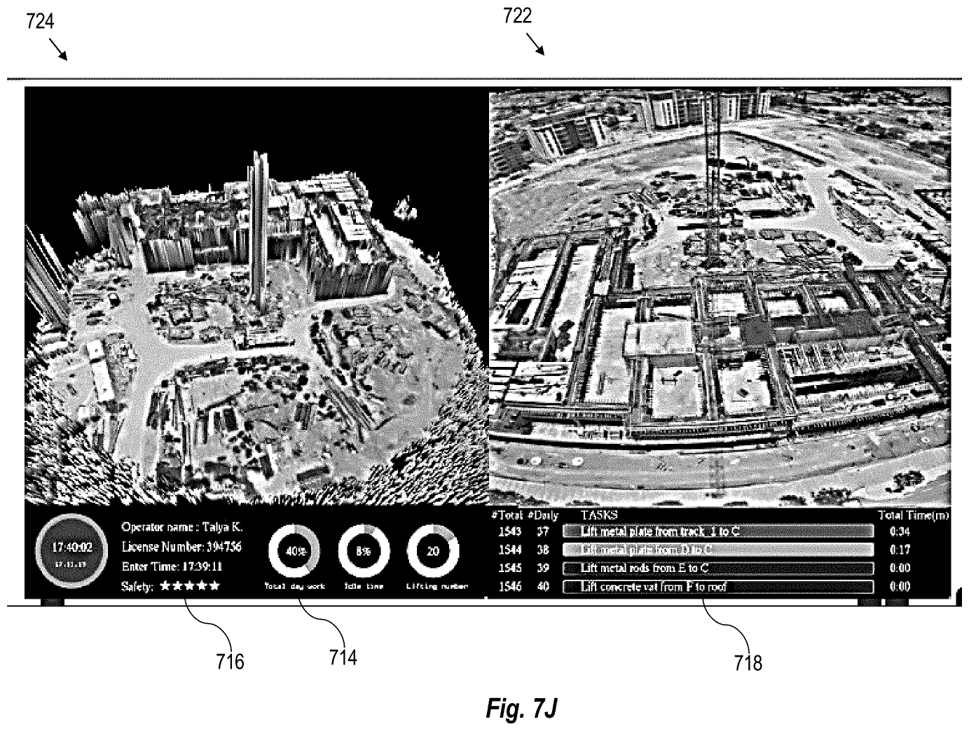

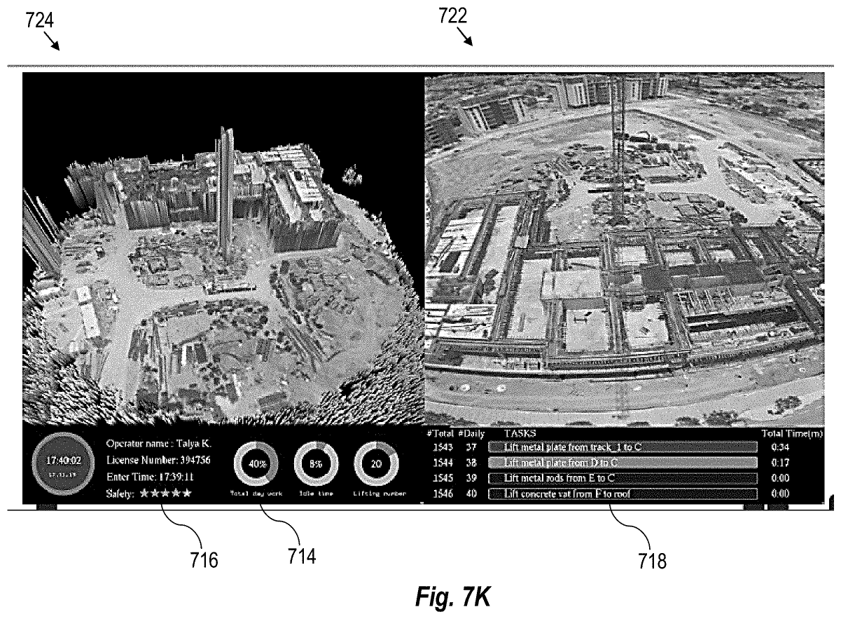

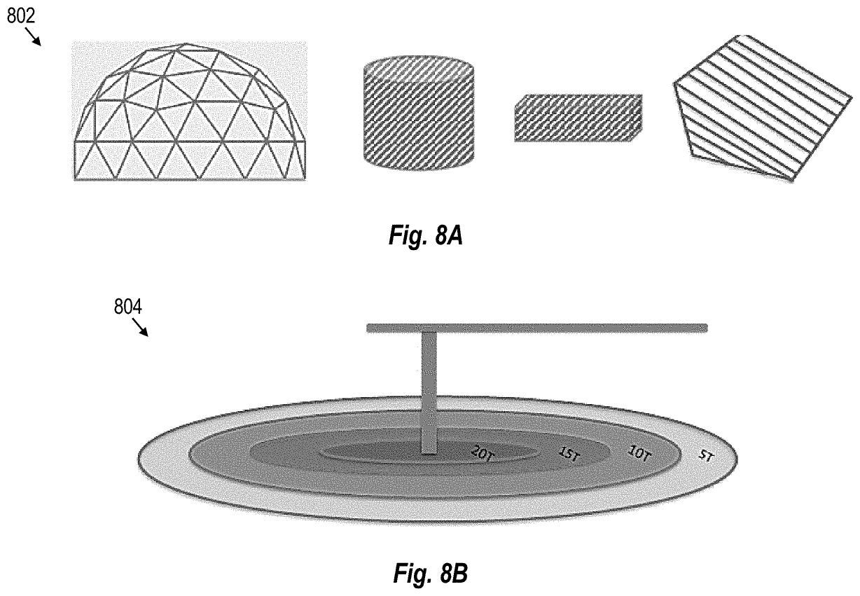

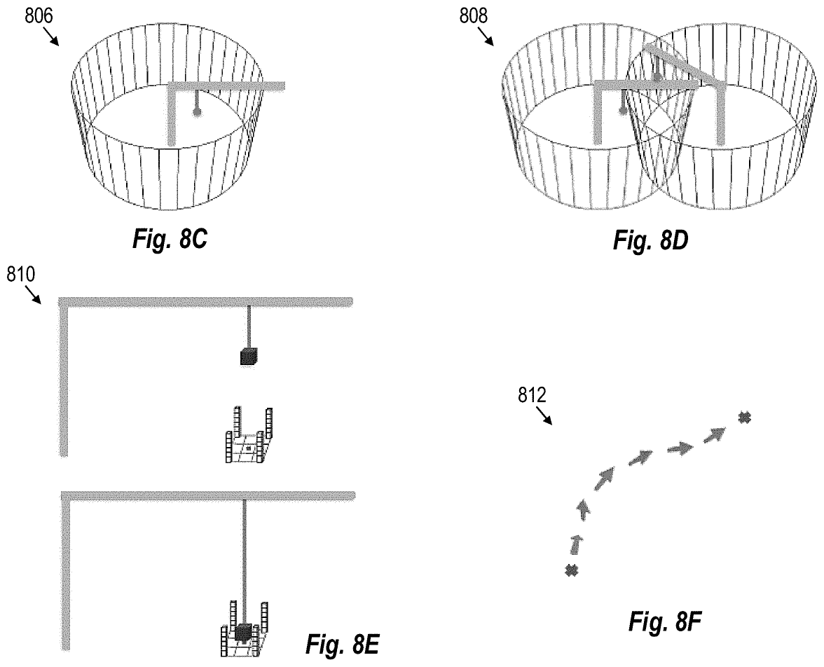

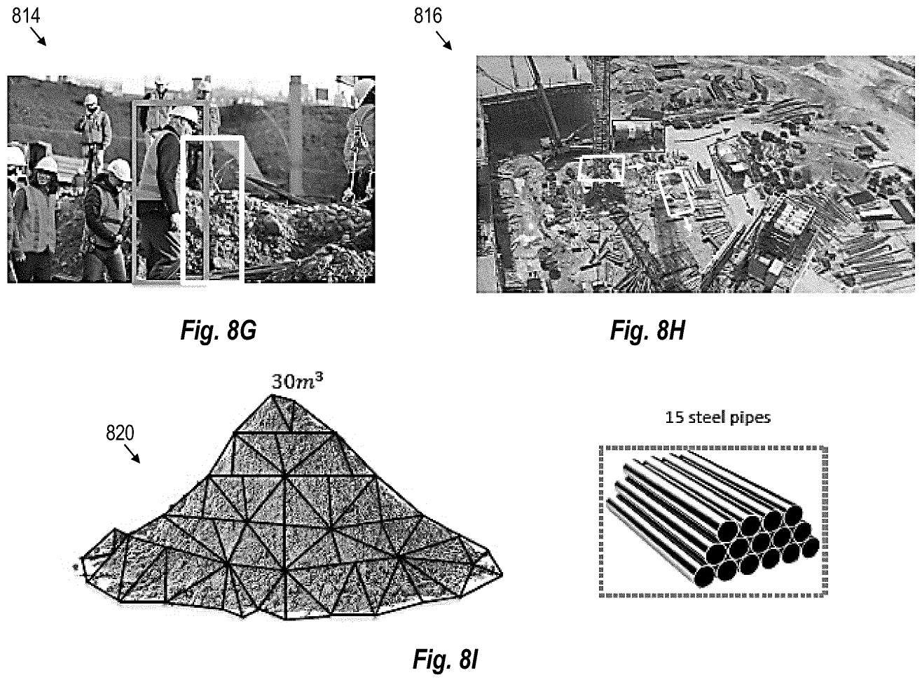

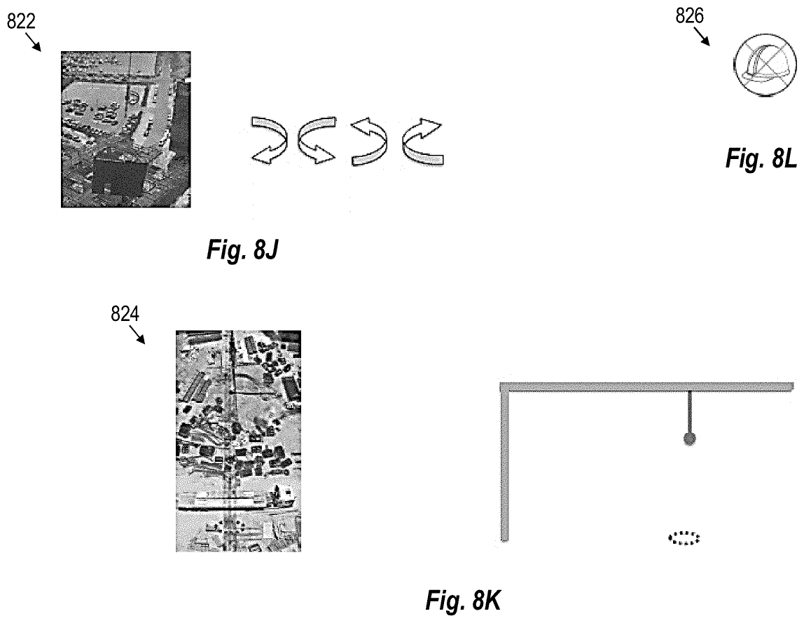

In some embodiments, processing module 242 may generate at least one of 2D graphics (e.g., in a display coordinates system) and 3D graphics (e.g., in a real-world coordinate system). Processing module 242 may enhance at least one of the first image sensor dataset, the second image sensor dataset and the 2D projection of the 3D model/textured 3D model with the 2D graphics and/or 3D graphics. Some examples of the 2D graphics and the 3D graphics are described below with respect to FIGS. 7A-7K and FIGS. 8A-8K, respectively.

In some embodiments, at least some of functions that may be performed by processing module 242 as described anywhere herein may be performed by first sensing unit processor 219.

Reference is now made to FIG. 3, which is a flowchart of a method of a remote operation of a tower crane performed by a system for remote operation of the tower crane, according to some embodiments of the invention.

The method may be implemented by, for example, processing module of a control unit of a system for remote control of a tower crane, such as system 100 and/or system 200 described above with respect to FIG. 1 and FIG. 2, respectively, which may be configured to implement the method. It is noted that the method is not limited to the flowcharts illustrated in FIG. 3 and to the corresponding description. For example, in various embodiments, the method need not move through each illustrated box or stage, or in exactly the same order as illustrated and described.

At 302, the processing module may receive a task. The task may include, for example, an origin point from which a cargo should be collected, a destination point to which the cargo should be delivered by the tower crane, and optionally cargo-related information (e.g., cargo type, cargo weight, etc.).

At 304, the task may be defined by the operator of the tower crane. For example, the operator may select the origin point, the destination point and the cargo on the display and optionally provide the cargo-related information.

At 306, the processing module may be retrieved from a task schedule manager. The task schedule manager may include, for example, a predefined set of tasks to be performed and an order thereof.

At 308, the processing module may obtain a 3D model of at least a portion of the construction site. The 3D model may be stored, for example, in database on the system or in an external database. The 3D model may be periodically determined and/or updated (e.g., as described above with respect to FIG. 2).

At 310, the processing module may obtain tower crane parameters. The tower crane parameters may include, for example, a physical model of the tower crane, tower crane limitations, tower crane type, tower crane installation parameters, tower crane general characteristics, etc.

At 312, the processing module may determine one or more route(s) for delivery of the cargo from the origin point to the destination point. The processing module may determine the route(s) based on the task and the 3D model (e.g., as described above with respect to FIG. 2) and optionally based the tower crane parameters and/or construction site parameters (e.g., such as defined safe zones, etc.).

At 314, the processing module may determine operation instructions based on the determined route(s). The operation instructions may include functions to be performed by the tower crane to perform the task.

At 316, the processing module may determine real-time kinematic parameters. The real-time kinematic parameters may include, for example, velocity, acceleration, etc. in one or more axes. The real-time kinematic parameters may be determined based on readings from the sensing units of the system. Optionally, at 314, the processing module may determine and/or update the operation instructions further based on the real-time kinematic parameters.

In some embodiments, at 318, the processing module may control the operation of the tower crane based on commands provided by the operator (e.g., as described above with respect to FIG. 2). The operator may make its instructions at least partly based on the operation instructions determined at 314 and/or based on the route(s) determined at 312.

In some embodiments, at 320, the processing module may automatically control the tower crane based on the operation instructions determined at 314 (e.g., as described above with respect to FIG. 2). The operator may, for example, have an override of the processing module.

At 322, the processing module may perform collision analysis based on the readings from the sensing units and the 3D model, and/or optionally based on data from an external system (e.g., as described above with respect to FIG. 2).

If a collision hazard is detected, the processing module may perform at least one of: issue a warning (at 324), update the route(s) (at 326) and update the 3D model (at 328).

When the task is complete, the processing module may optionally update the task schedule (at 330).

Reference is now made to FIG. 4A, which is a flowchart of a method of determining real-world orientations of two or more image sensors in a real-world coordinate system based on image datasets obtained by the image sensors thereof, according to some embodiments of the invention.

Reference is now made to FIG. 4B, which depicts an example of determining real-world orientations of two or more image sensors in a real-world coordinate system based on image datasets obtained by the image sensors thereof, according to some embodiments of the invention.

The method may be performed by, for example, a processing module of a control unit of a system for remote control of a tower crane to determine sensing-units calibration data (e.g., as described above with respect to FIG. 2).

The method may include obtaining a first image sensor dataset by a first image sensor and obtaining a second image dataset by a second image sensor, wherein fields-of-view of the first image sensor and of the second image sensor at least partly overlap with each other (stage 402). For example, first image sensor 430 and second image sensor 434 shown in FIG. 4B. For example, the first image sensor may be like at least one first image sensor 212 of first sensing unit 210, and the second image sensor may be like at least one second image sensor 222 of second sensing unit 220, as described above with respect to FIG. 2.

The method may include detecting three or more objects in the first image sensor dataset (stage 404), for example, objects 440 shown in FIG. 4B.

The method may include detecting the three or more objects in the second image sensor dataset (stage 406), for example, objects 440 shown in FIG. 4B.

The method may include determining, based on a virtual model of the first image sensor, three or more first vectors in a first image sensor coordinate system, each of the first vectors extending between the first image sensor and one of the three or more detected objects (stage 408), for example, first vectors 431 shown in FIG. 4B.

The method may include determining, based on a virtual model of the second image sensor, three or more second vectors in a second sensor coordinate system, each of the second vectors extending between the second image sensor and one of the three or more detected objects (stage 410), for example, second vectors 435 shown in FIG. 4B.

The method may include determining an image sensors position vector extending between the first image sensor and the second image sensor in the first image sensor coordinate system and an orientation of the second image sensor with respect to the first image sensor in the first image sensor coordinate system based on the three or more first vectors and the three or more second vectors (stage 416). For example, image sensors position vector 450 shown in FIG. 4B. For example, the image sensors position vector may be determined based on an intersection of the three or more first vectors in the first image sensor coordinate system and an intersection between the three or more second vectors in the second sensor coordinate system.

The method may include obtaining a first real-world geographic location of the first image sensor in the real-world coordinate system (stage 418). For example, the first-real world geographic location may be determined using a GPS sensor of first sensing unit 210 (e.g., included in additional sensor(s) 216) as described above with respect to FIG. 2.

The method may include obtaining a second real-world geographic location of the second image sensor in the real-world coordinate system (stage 420). For example, the first-real world geographic location may be determined using a GPS sensor of first sensing unit 220 (e.g., included in additional sensor(s) 226) as described above with respect to FIG. 2.

The method may include determining a real-world orientation of the first image sensor in the real-world coordinate system based on the determined image sensors position vector, the obtained first real-world location of the first image sensor and the obtained second real-world location of the second image sensor (stage 422).

The method may include determining a real-world orientation of the second image sensor in the real-world coordinate system based on the determined real-world orientation of the first image sensor and the determined orientation of the second image sensor with respect to the first image sensor (stage 424).

For example, the real-world orientation of the first image sensor (o_{w}¹) and the real-world orientation of the second image sensor (o_{w}²) in the real-world coordinate system may be determined based on Equation 1 and Equation 2, as follows:

o_{w}¹·p₁²=[r₁−r₂] (Equation 1)

o_{w}²=o_{w}¹·o₁² (Equation 2)

wherein o_{w}¹ is the real-world orientation of the first image sensor in the real-world coordinate system, o_{w}² is the real-world orientation of the second image sensor in the real-world coordinate system, p₁² is the image sensors position vector in the first image sensor coordinate system, o₁² is orientation of the second image sensor with respect to the first image sensor in the first image sensor coordinate system, r₁ is the obtained first real-world geographic location of the first image sensor in the real-world coordinate system, and r₂ is the obtained second real-world geographic location of the second image sensor in the real-world coordinate system.

The method may be performed by, for example, a processing module of a control unit of a system for remote control of a tower crane to determine sensing-units calibration data (e.g., as described above with respect to FIG. 2). The method may provide an accurate calculation of real-world orientations of the sensing units. For example, typical accuracy of some low-end GPS sensors may be about 0.6 m and typical length of the jib of the tower crane is about 60 m, which may provide an accuracy of the real-world orientations of the sensing units of 1.5-3 mrad.

Reference is now made to FIG. 5, which is a flowchart of a method of determining a misalignment between two or more image sensors, according to some embodiments of the invention.

The method may be performed by, for example, a processing module of a control unit and/or by a first sensing unit processor of a system for remote control of a tower crane as a part of a built-in-test to determine misalignment between the sensing units (e.g., as described above with respect to FIG. 2).

The method may include obtaining a first image sensor dataset by a first image sensor and obtaining a second image dataset by a second image sensor, wherein fields-of-view of the first image sensor and of the second image sensor at least partly overlap with each other (stage 502). For example, the first image sensor may be like at least one first image sensor 212 of first sensing unit 210, and the second image sensor may be like at least one second image sensor 222 of second sensing unit 220, as described above with respect to FIG. 2.

The method may include detecting an object in the first image sensor dataset and detecting the object in the second image dataset (stage 504). For example, a center pixel in the object may be detected.

The method may include determining whether a misalignment between the first image sensor and the second image sensor is above a predetermined threshold based on the detections and a predetermined image sensors calibration data (stage 506). For example, the predetermined image sensors calibration data may be similar to the sensing-units calibration data and may include at least real-world orientations of the first image sensor and the second image sensor in the reference system, as described above with respect to FIG. 2. The image sensors calibration data may be predetermined as, for example, described above with respect to FIGS. 4A and 4B.

Reference is now made to FIG. 6, which is a flowchart of a method of determining a real-world geographic location of at least one object based on image datasets obtained by two image sensors, according to some embodiments of the invention.

The method may be performed by a processing module of a control unit of a system for a remote control of a tower crane, such as system 100 and system 200 described above with respect to FIGS. 1 and 2, respectively, to determine tower crane real-world geographic location data (e.g., as described above with respect to FIG. 2).

The method may include obtaining a first image sensor dataset by a first image sensor and obtaining a second image dataset by a second image sensor, wherein fields-of-view of the first image sensor and of the second image sensor at least partly overlap with each other (stage 602). For example, the first image sensor may be like at least one first image sensor 212 of first sensing unit 210 and the second image sensor may be like at least one second image sensor 222 of second sensing unit 220, as described above with respect to FIG. 2.

The method may include detecting a specified object in the first image sensor dataset and detecting the specified object in the second image sensor dataset (stage 604). In some embodiments, the detections may be may using machine learning methods (e.g., such as CNN and/or RNN). For example, the specified object may be a hook of a tower crane and/or a cargo carried thereby (e.g., as described above with respect to FIGS. 1 and 2).

The method may include determining an azimuth and an elevation of the specified object in a real-world coordinate system based on the detections and a predetermined image sensors calibration data (stage 606). For example, the predetermined image sensors data may be similar to the sensing-units calibration data and may include at least real-world orientations of the first image sensor and of the second image sensor in the reference system, as described above with respect to FIG. 2. The image sensors calibration data may be predetermined as, for example, described above with respect to FIGS. 4A and 4B.

The method may include determining a real-world geographic location of the specified object based on the determined azimuth and elevation and a predetermined distance between the first image sensor and the second image sensor (stage 608). For example, the predetermined distance may be the predetermined sensing-units distance as described above with respect to FIGS. 1 and 2.

In some embodiments, the method may include determining a real-world geographic location of at least one additional object based on the determined real-world geographic location of the specified object. For example, if the specified object is a hook of the tower crane and/or a cargo carried thereby, the method may include determining the position of the trolley of the tower crane along the jib thereof and/or an angle of the jib with respect to North based on the determined real-world geographic location of the hook/cargo.

Reference is now made to FIGS. 7A-7I, which depict examples of a two-dimensional (2D) graphics for enhancing an image of a construction site being displayed on a display of a system for remote operation of a tower crane, according to some embodiments of the invention.

Reference is also made to FIGS. 7J and 7K, which depict examples of images of a construction site being displayed on a display of a system for remote operation of a tower crane, wherein the images are enhanced with at least some of the 2D graphics of FIGS. 7A-7I, according to some embodiments of the invention.

FIG. 7A depicts a 2D graphics 702 presenting a jib of the tower crane, trolley position along the jib and jib's stoppers. 2D graphics 702 may, for example, flash in the case of a hazard. The position of the trolley along the jib may be determined by the processing module based on image datasets from the sensing units of the system, for example as described above with respect to FIGS. 2 and 6.

FIG. 7B depicts a 2D graphics 704 presenting an angular velocity of the jib. The angular velocity of the jib may be determined by the processing module based on readings of, for example, inertial sensor(s) of the sensing unit(s) of the system. In another example, the angular velocity of the jib may be determined by the processing module based on readings of the first image sensor and/or the second image sensor (e.g., based on a difference between two or more subsequent image frames).

FIG. 7C depicts a 2D graphics 706 presenting a jib direction and a wind direction with respect to North. The wind direction may be determined by the processing module based on readings of anemometer of the sensing unit(s) of the system or an external source (e.g., forecast providers, internet sites, etc.). The jib direction may be determined by the processing module based on image datasets from the sensing units of the system, for example as described above with respect to FIGS. 2 and 6 and/or readings of GPS.

FIG. 7D depicts a 2D graphics 708 presenting status of the input device(s) of the system.

FIG. 7E depicts a 2D graphics 710 presenting a height of the hook (e.g., height above the ground and/or below the texture). The height of the hook may be determined by the processing module based on image datasets from the sensing units of the system, for example as described above with respect to FIGS. 2 and 6.

FIG. 7F depicts a 2D graphics 712 presenting a relative panorama viewpoint. The relative panorama viewpoint may be determined by the processing unit based on input device(s) and/or LOS of the operator (e.g., as described above with respect to FIG. 2).

FIG. 7G depicts a 2D graphics 714 presenting statistical process control.

FIG. 7H depicts a 2D graphics 716 presenting an operator card.

FIG. 7I depicts a 2D graphics 718 presenting a task bar.

FIG. 7J depicts an image dataset 720 obtained by one of the sensing units of the system, wherein image dataset is enhanced with 2D graphics 702, 704, 706, 708, 710, 712.

FIG. 7K depicts an image dataset 722 obtained by one of the sensing units of the system enhanced with 2D graphics 718 and a 2D projection 274 of the textured 3D model enhanced with 2D graphics 714 and 716.

Visual parameters of the 2D graphics may be determined by the processing module of the control unit of the system based on the image of the construction site being displayed. The visual parameters may include, for example, position on the display, transparency, etc. For example, the processing unit may determine the visual parameters of the 2D graphics such that the 2D graphics does not obstruct any important information being displayed on the display. In some embodiments, the 2D graphics may be determined based on a display coordinate system. The 2D graphics may include, for example, De Clatter or graphic symbols.

Reference is now made to FIGS. 8A-8L, which depict examples of a three-dimensional (3D) graphics for enhancing an image of a construction site being displayed on a display of a system for remote operation of a tower crane, according to some embodiments of the invention.

FIG. 8A depicts a 3D graphics 802 presenting different zones in the construction site. Such zones may be, for example, closed area zones or safe area zones. For example, the processing unit may, for example, set the color for different zone types (e.g., red color for closed area zone and blue color for safe area zone). 3D graphics 802 may have different shapes and dimensions.

FIG. 8B depicts a 3D graphics 804 presenting weight zones. The weight zones may be determined by the processing module based on the site parameters, tower crane parameters and weight of the cargo.

FIG. 8C depicts a 3D graphics 806 presenting a tower crane maximal cylinder zone. The tower crane maximal cylinder zone may be determined by the processing module based on the tower crane parameters.

FIG. 8D depicts a 3D graphics 808 presenting a tower crane cylinder zone overlap with a tower crane cylinder zone of another crane. The overlap may be determined by the processing module based on the tower crane parameters.

FIG. 8E depicts a 3D graphics 810 presenting current cargo position and cargo drop position (e.g., in real-world coordinate system). The current cargo position may be determined by the processing module based on the image dataset from the sensing unit(s) of the system (e.g., as described above with respect to FIG. 2). The cargo drop position may be defined by the operator (e.g., as described above with respect to FIG. 2).

FIG. 8F depicts a 3D graphics 312 presenting a lift to drop route enhanced with a 3D grid to enhance understanding of the route. The lift to drop route may be determined by the processing module (e.g., as described above with respect to FIG. 2).

FIG. 8G depicts a 3D graphics 814 presenting a specified person on in the construction site. The specified person may be, for example, a construction site manager. The specified person may be detected by the processing module based on image datasets from the sensing unit(s) of the system.

FIG. 8H depicts a 3D graphics 816 presenting moving elements, their velocities and/or estimated routes. The moving elements, their velocities and/or estimated routes may be determined by the processing module based on image datasets from the sensing unit(s) of the system.

FIG. 8I depicts a 3D graphics 820 presenting bulk material and/or the estimated amount thereof. The bulk material and/or the estimated amount thereof may be determined by the processing module based on image datasets from the sensing unit(s) of the system.

FIG. 8J depicts a 3D graphics 822 presenting hook turn direction. The hook turn direction may be determined by the processing module based on image datasets from the sensing unit(s) of the system.

FIG. 8K depicts a 3D graphics 824 presenting hook ground position (e.g., in real-world coordinate system). The hook ground position may be determined by the processing module based on image datasets from the sensing unit(s) of the system.

FIG. 8L depicts a 3D graphics 826 presenting safety alerts. The safety alerts may be determined by the processing module based on image datasets from the sensing unit(s) of the system.

Visual parameters of the 3D graphics may be determined by the processing module of the control unit of the system based on the image of the construction site being displayed. The visual parameters may include, for example, position on the display, transparency, etc. For example, the processing unit may determine the visual parameters of the 3D graphics such that the 3D graphics does not obstruct any important information being displayed on the display. In some embodiments, the 3D graphics may be determined based in the reference/real-world coordinate system.

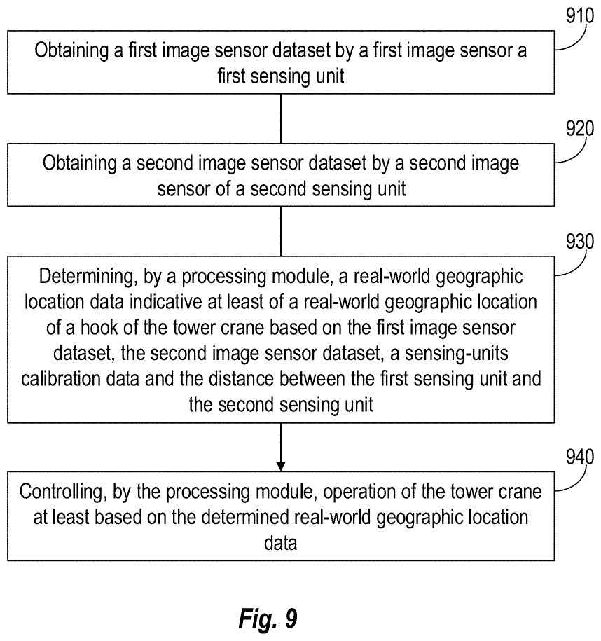

Reference is now made to FIG. 9, which is a flowchart of a method of a remote control of a tower crane, according to some embodiments of the invention.

The method may be implemented by a system for remote control of a tower crane (such as system 100 and system 200 described hereinabove), which may be configured to implement the method.

The method may include obtaining 910 a first image sensor dataset by a first image sensor a first sensing unit. For example, as described hereinabove.

The method may include obtaining 920 a second image sensor dataset by a second image sensor of a second sensing unit, wherein the first sensing unit and the second sensing unit are disposed on a jib of a tower crane at a distance with respect to each other such that a field-of-view of the first sensing unit at least partly overlaps with a field-of-view of the second sensing unit, for example, as described hereinabove.

The method may include determining 930, by a processing module, a real-world geographic location data indicative at least of a real-world geographic location of a hook of the tower crane based on the first image sensor dataset, the second image sensor dataset, a sensing-units calibration data and the distance between the first sensing unit and the second sensing unit, for example, as described hereinabove.

The method may include controlling 940, by the processing module, operation of the tower crane at least based on the determined real-world geographic location data, for example, as described hereinabove.

In some embodiments, the first sensing unit and the second sensing unit are multispectral sensing units each comprising at least two of: MWIR optical sensor, LWIR optical sensor, SWIR optical sensor, visible range optical sensor, LIDAR sensor, GPS sensor, one or more inertial sensors, anemometer, audio sensor and any combination thereof, for example, as described hereinabove.

Some embodiments may include determining a three-dimensional (3D) model of at least a portion of a construction site based on the first image sensor dataset and the second image sensor dataset, the 3D model comprising a set of data values that provide a 3D presentation of at least a portion of the construction site, wherein real-world geographic locations of at least some of the data vales of the 3D model are known, for example, as described hereinabove.

Some embodiments may include determining the 3D model further based on a LIDAR dataset from at least one of the first sensing unit and the second sensing unit, for example, as described hereinabove.

Some embodiments may include generating a two-dimensional (2D) projection of the 3D model, for example, as described hereinabove.

Some embodiments may include displaying at least one of the generated 2D projection, the first image sensor dataset and the second image sensor dataset on a display, for example, as described hereinabove.

Some embodiments may include determining the 2D projection of the 3D model based on at least one of: operator's inputs received using one or more input devices, a line-of-sight (LOS) of the operator tracked by a LOS tracker, and an external source, for example, as described hereinabove.

Some embodiments may include receiving a selection of one or more points of interest made by an operator based on at least one of a 2D projection of the 3D model, the first image sensor dataset and the second image sensor dataset being displayed on a display, for example, as described hereinabove.

Some embodiments may include determining a real-world geographic location of the one or more points of interest based on a predetermined display-to-sensing-units coordinate systems transformation, a predetermined sensing-units-to-3D-model coordinate systems transformation and the 3D model, for example, as described hereinabove.

Some embodiments may include receiving an origin point of interest in the construction site from which a cargo should be collected and a designation point of interest in the construction site to which the cargo should be delivered. For example, as described hereinabove.

Some embodiments may include determining real-world geographic locations of the origin point of interest and the destination point of interest based on the 3D model, for example, as described hereinabove.

Some embodiments may include determining one or more routes between the origin point of interest and the destination point of interest based on the determined real-world geographic locations and the 3D model, for example, as described hereinabove.

Some embodiments may include generating, based the one or more determined routes, operational instructions to be performed by the tower crane to complete a task, for example, as described hereinabove.

Some embodiments may include automatically controlling the tower crane based on the operational instructions and the real-world geographic location data, for example, as described hereinabove.

Some embodiments may include displaying at least one of the one or more determined routes and the operational instructions to the operator and control the tower crane based on the operator's input commands, for example, as described hereinabove.

Some embodiments may include detecting a collision hazard based on the first image sensor dataset, the second image sensor dataset, the determined real-world geographic location data and the 3D model, for example, as described hereinabove.

Some embodiments may include detecting an object in the construction site in at least one of the first image sensor dataset and the second image sensor dataset, for example, as described hereinabove.

Some embodiments may include determining a real-world geographic location of the detected object based on the 3D model, for example, as described hereinabove.

Some embodiments may include determining whether there is a hazard of collision of at least one component of the tower crane and a cargo with the detected object based on the determined real-world geographic location of the detected object and the determined real-world geographic location data, for example, as described hereinabove.

Some embodiments may include issuing a notification if a hazard of collision is detected, for example, as described hereinabove.

Some embodiments may include one of updating and changing the route upon detection of the collision hazard, for example, as described hereinabove.

In some embodiments, the one or more points of interest comprising a safety zone to which a cargo being carried by the tower crane should be delivered in the case of failure of the system, for example, as described hereinabove.

Some embodiments may include generating aerial platform data values by an aerial platform configured to navigate in at least a portion of the construction site, the aerial platform data values providing a 3D presentation of at least a portion of a construction site, for example, as described hereinabove.

Some embodiments may include updating the 3D model based on at least a portion of the aerial platform data values, for example, as described hereinabove.

Some embodiments may include comparing the determined 3D model with at least one preceding 3D model, for example, as described hereinabove.

Some embodiments may include presenting the comparison results indicative of a construction progress made to at least one of the operator and an authorized third party, for example, as described hereinabove.

Some embodiments may include generating a 2D graphics with respect to a display coordinate system, for example, as described hereinabove.

Some embodiments may include enhancing at least one of the first image sensor data, the second image sensor data and a 2D projection of a 3D model being displayed on the display with the 2D graphics, for example, as described hereinabove.

In some embodiments, the 2D graphics comprises visual presentation of at least one of: a jib of the tower crane, trolley position along the jib and jib's stoppers, an angular velocity of the jib, a jib direction with respect to North, a wind direction with respect to North, status of one or more input devices of the system, height of a hook above a ground, a relative panorama viewpoint, statistical process control, an operator card, a task bar and any combination thereof, for example, as described hereinabove.

Some embodiments may include generating a 3D graphics with respect to a real-world coordinate system, for example, as described hereinabove.

Some embodiments may include enhancing at least one of the first image sensor data, the second image sensor data and a 2D projection of the 3D model being displayed on the display with the 3D graphics, for example, as described hereinabove.

In some embodiments the 3D graphics comprises visual presentation of at least one of: different zones in the construction site, weight zones, a tower crane maximal cylinder zone, a tower crane cylinder zone overlap with a tower crane cylinder zone of another crane, current cargo position and cargo drop position, a lift to drop route, a specified person on in the construction site, at least one of moving elements, velocity and estimated routes thereof, at least one of bulk material and the estimated amount thereof, hook turn direction, safety alerts and any combination thereof, for example, as described hereinabove.

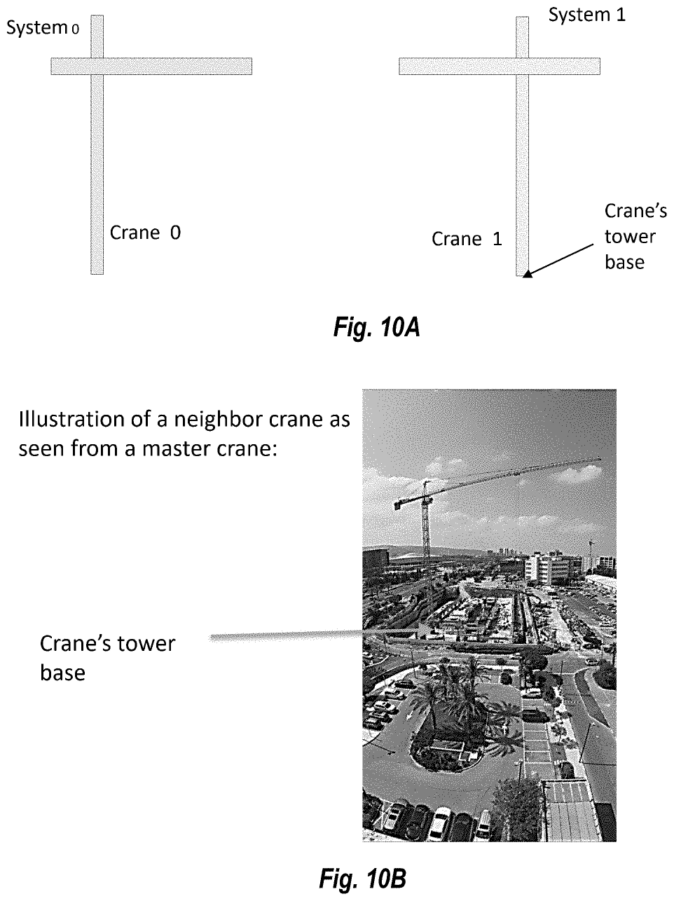

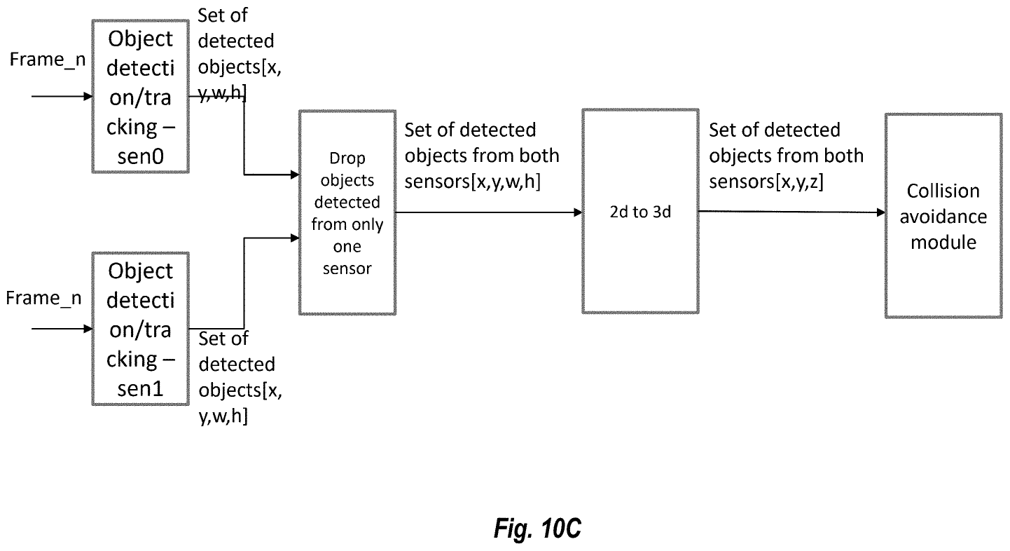

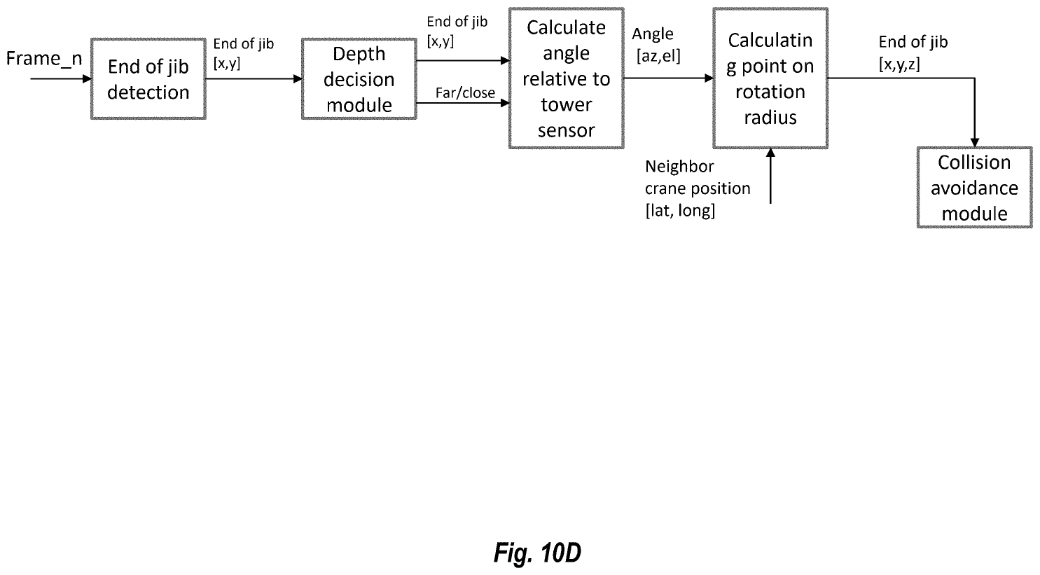

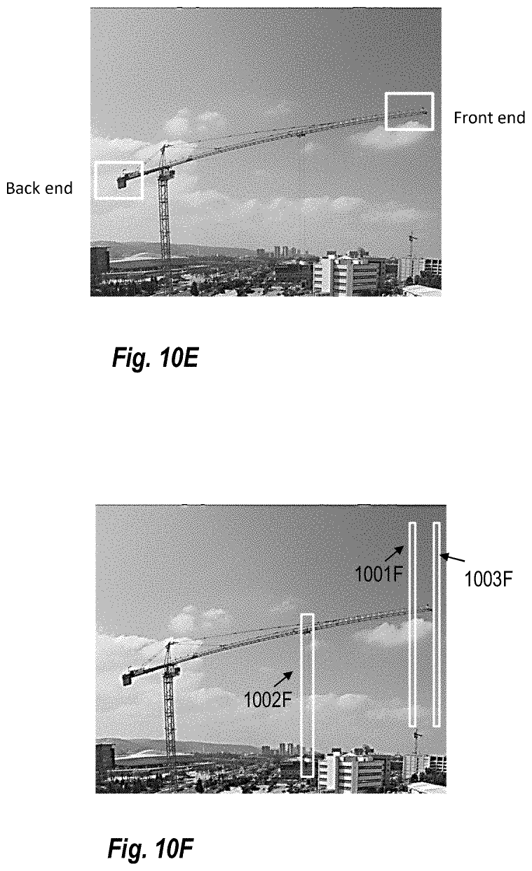

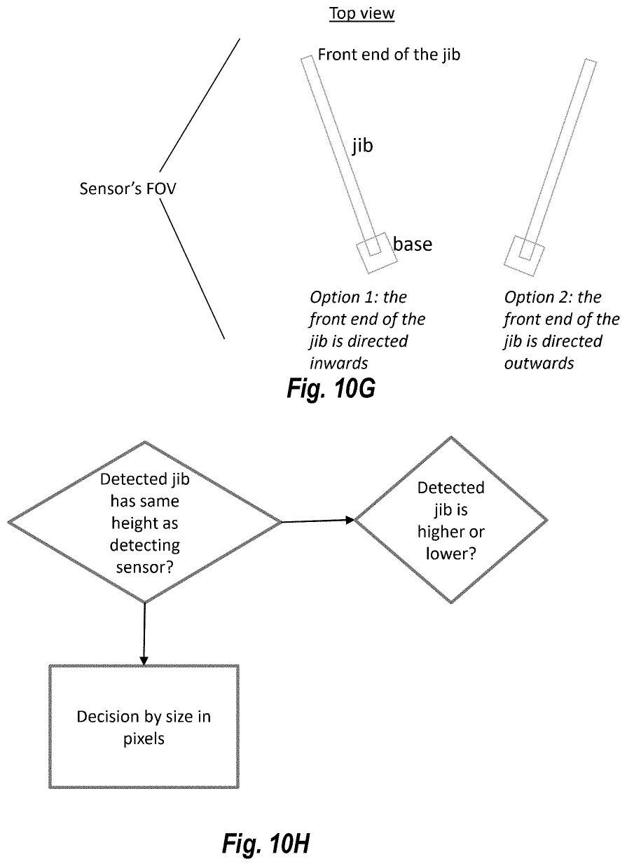

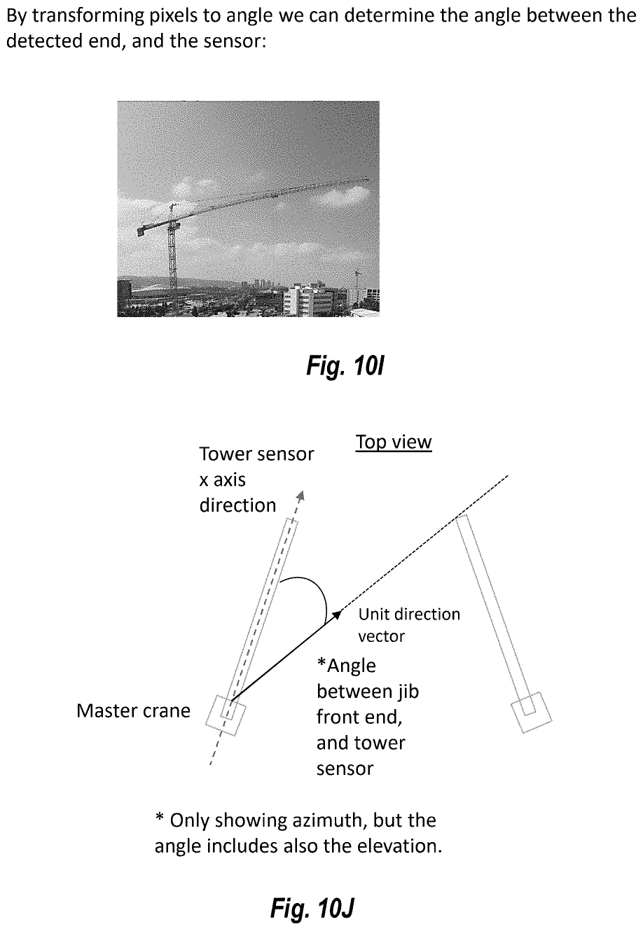

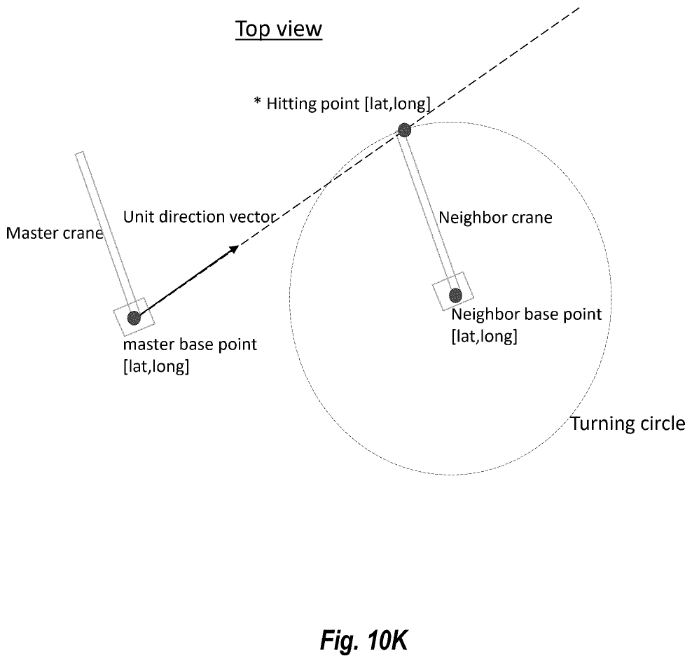

FIGS. 10A-10D depicts various diagrams illustrating collision detection and avoiding when two or more cranes are positioner in close proximity to each other according to some embodiments of the invention.

According to some embodiments of the present invention, it is possible to detect and avoid collisions when two or more cranes are operating proximal to each other. The objective is to identify objects around the crane which might cause a collision with either the crane or the load.

Such objects can be static (maintains position and orientation): such as buildings, ground, building materials. This can be semi-dynamic (maintain position but changes orientation) such as anther crane in the site, or they can be dynamic such as cars, people, construction vehicles.

FIGS. 10A-10D illustrate such environment of two cranes and a system that assists in collision avoidance. The system may include two sensors and a ground cabin (optional). The master crane is defined as the crane on which the system works. Each functioning system on site has its own master crane. The neighboring cranes are defined as other cranes on site in addition to a master crane. The may or may not have a system on them. The crane's position is defined by GPS data (altitude and longitude) of the crane's tower base.

Embodiments of the present invention work under the following assumptions:
Master crane's position and orientation are known
Position of any other neighbor crane is known
Height and jib length of any other neighbor crane are known

The anti-collision module may receive all the obstacles on the site and the crane's speed and orientation and determine whether the crane might collide with anything.

According to embodiments of the present invention, two level of actions are possible:

passive: the hazard is far enough to operate safely but attention is required; and active: command the crane to avoid collision (turning, trolly, hook) and even halt the crane at extreme conditions.

FIG. 10E is an image of a crane processed using deep neural networks demonstrating how is possible to identify either end of the jib (back end and front end).

FIG. 10F is an image of a crane processed using deep neural networks demonstrating that once either end of the jib has been detected, the relative direction of the base needed to be found. It can be achieved by searching for the crane on either side of the end. By using image correlation of the jib, it can be determined by the system in accordance with embodiments of the present invention, on which strip the crane ends. In this case, the output will be: Location [X, Y] Direction=left, as rectangles 1001F and 1003F allow detecting where the jib is.

Detection of hook and trolly position can be also be achieved as seen in rectangle 1002F—two cranes can overlap as long as they are not in the same height and the trolley circle is not in conjunction, distance is known and it is possible to can count pixels and calculate the position.

FIG. 10G shows a diagram of the system which can pick one of the two options: Option 1: the front end of the jib is directed inwards and Option 2: the front end of the jib is directed outwards.

FIG. 10I shows an image of a crane demonstrating that of by transforming pixels to angle the system in accordance with embodiments of the present invention can determine the angle between the detected end, and the sensor.

FIG. 10J a diagram of two cranes showing the detected and monitored angle between jib front end, and tower sensor.

FIG. 10K is a diagram showing how the system can calculate the point on the turning circle of the neighbor crane in which the direction vector hits the circle.

Now referring to another embodiment of the present invention, it would be further advantage to use specifically tailored symbology for crane operators as described below:

In accordance with embodiment of the present invention, two modes of displays are used:
1. Manual→Operators manual control on display field of view and zoom using joysticks controls.
2. 2. Automatic→Zoom and field of view are automatic and pending the hook height above the ground. The basic assumption is that the position of the Hook and trolley and the direction of the jib is known to the system by sensing units and Imagery processing capabilities.

The suggested symbology may include:
Automatic mode: In auto mode the operator display field of view will always include the crane hook and the point on the ground below it—tracking will be automatically by the system vision and other crane sensors (see the below drawing).
Graphics in auto mode: Ground position of the hook—Oval, the ratio of its axes according to the distance of the trolley and the height of the hook above the ground.
Ground trajectory of Jib movement—A semicircle with a radius according to the distance of the trolley and the height of the hook above ground.
Hook height above the ground: A vertical line from the hook to the center of the circle below, with marks every 5 meters (configurable), color and line change pending hook height above the ground.
Hook marker and next to it above ground height actual measurement number
Field of view (FOV) and Zoom in auto mode: FOV includes the hook and the below point on the ground. Higher above ground hook height higher FOV, and vice versa lower hook height above the ground smaller FOV
Higher above ground hook height Lower Zoom, and vice versa lower hook height above the ground Higher Zoom
When hook height is below a certain height (configurable) a pop-up window of additional cameras (edge camera, trolley camera) will be shown up, in picture in picture mode.
Graphics in auto mode for platform motion rates (hook, trolley, and jib)
for each element/axis add the below symbol in the center of view
Middle circle only—no motion, more “chevrons” more velocity for the relevant direction.

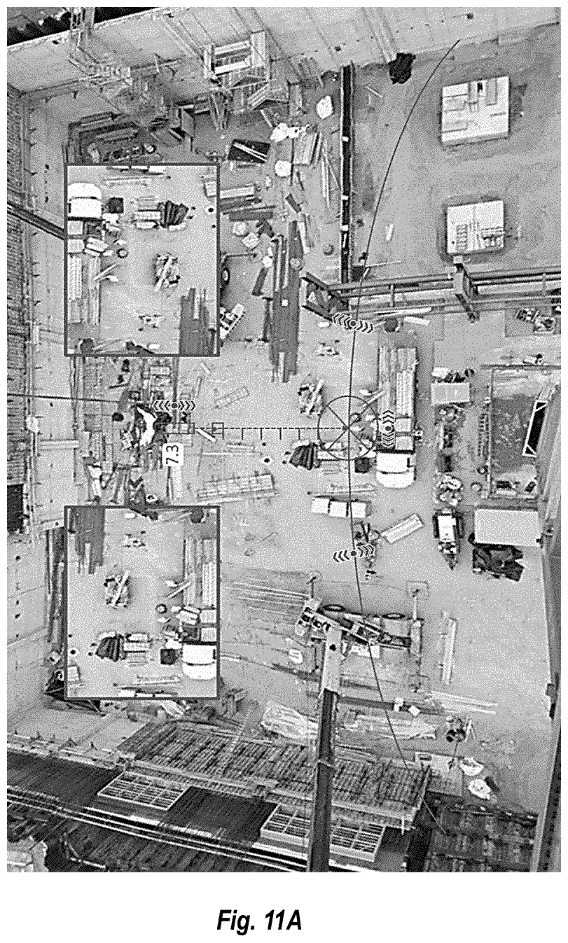

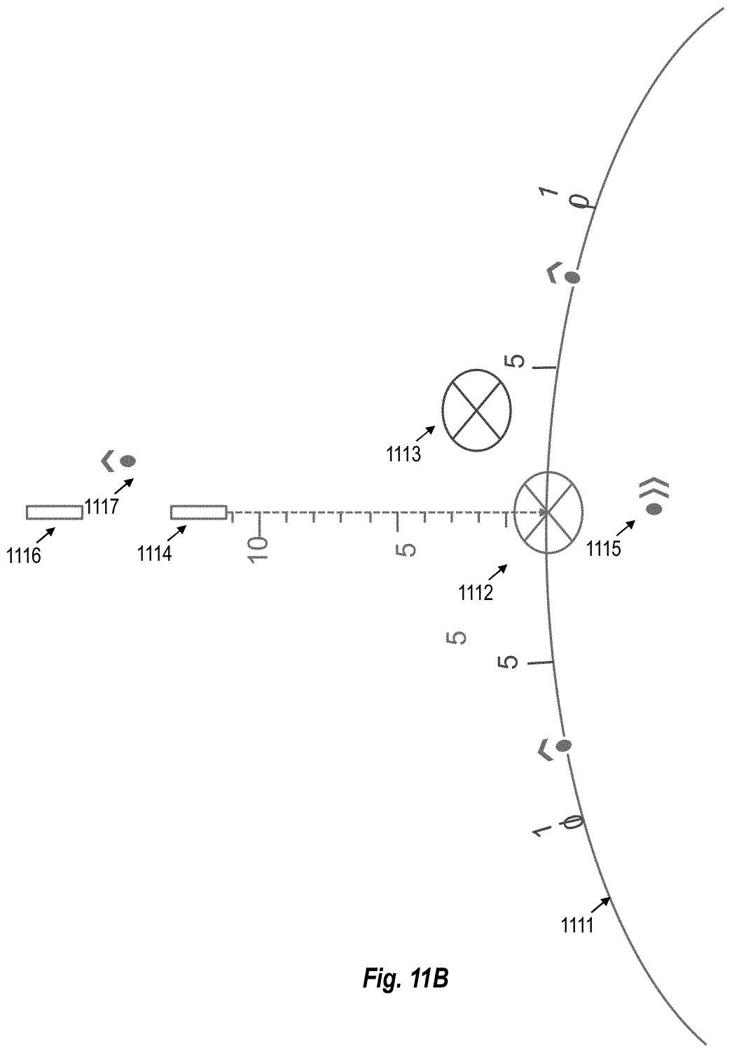

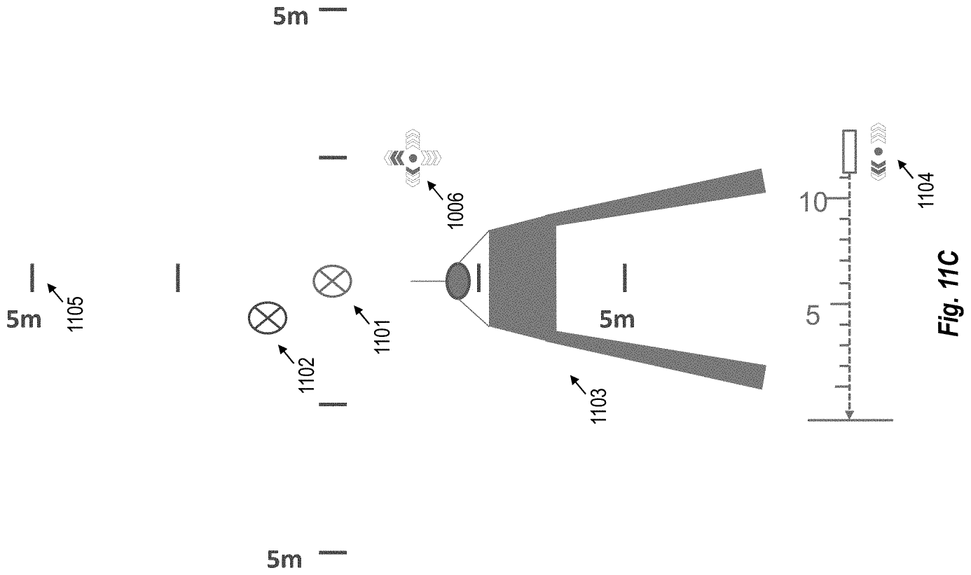

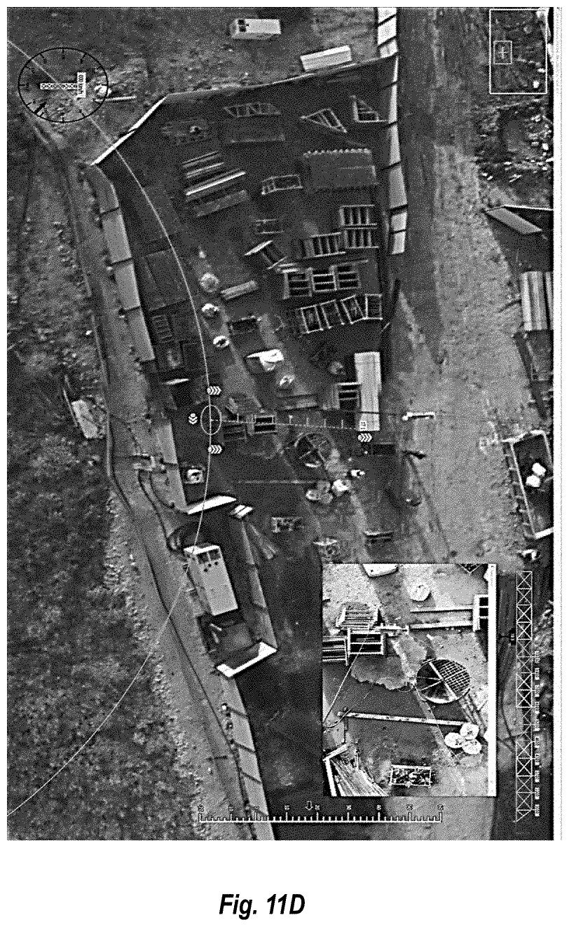

FIGS. 11A-11D depicts diagrams illustrating operator symbology as suggested above used in embodiments in accordance with the present invention.

FIG. 11A shows augmented reality symbology that as applied on the scene as seen by the operator.

FIG. 11B shows augmented reality symbology that may be applied on the scene as seen by the operator of FIG. 11A. 1116 represents the hook. 1112 represents the spot below the hook. 1113 represents the stopping spot based on current directivity and speed. 1115 represents directivity and speed. 1117 represents speed on the vertical axis. 1111 represents arc along which the hook moves.

FIG. 11C shows augmented reality symbology that may be applied on the scene as seen by the operator. 1103 represents the hook. 1101 represents the spot below the hook. 1102 represents the stopping spot based on current directivity and speed. 1006 represents directivity and speed. 1104 represents speed on the vertical axis. 1105 represents distance estimation.

FIG. 11D shows augmented reality symbology that as applied on the scene as seen by the operator.

As seen in the symbology, the following features may be presented to the operator:
Display working spot (current)
Display hook height
3D motion alerts/motion alerts based on ground objects
The best traffic route with reference to 3D (especially in a tall building)
Displays a motion arc
Display of expected stop point if currently leaving a stick
With and without optimal braking
Display distance on the ground (corrected zoom, both hook and lever)
Mark HOME in favor of automatic return
Displays a horizon image for a sense of movement
Display cart image/wire tension
Viewing a schedule of photos of the loading area (from three directions)
Automatic zoom according to level/download/movement rate
Display of a marker where to proceed (according to information coming from a guide)
Schedule work on a pair of cranes from a single control position
Another work position to direct where he performs planning of the activity
Each task includes marking on the ground what to move/from where and to where
Speed of movement
Corrected according to the position of the cart (so that it will always move in a linear world).

Advantageously, the disclosed systems and method may enable remote control of a tower crane and enhance situational awareness and/or safety.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions thereof. The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams can represent a module, segment, or portion of code, which includes one or more executable instructions for implementing the specified logical function(s). It should also be noted that, in some alternative implementations, the functions noted in the portion can occur out of the order noted in the figures. For example, two portions shown in succession can, in fact, be executed substantially concurrently, or the portions can sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for a remote control of a tower crane, the system comprising:
a first sensing unit comprising a first image sensor configured to generate a first image sensor dataset;
a second sensing unit comprising a second image sensor configured to generate a second image sensor dataset;
wherein the first sensing unit and the second sensing unit are adapted to be disposed on a jib of a tower crane at a distance with respect to each other such that a field-of-view of the first sensing unit at least partly overlaps with a field-of-view of the second sensing unit; and
a control unit comprising a processing module configured to:
determine a real-world geographic location data indicative at least of a real-world geographic location of a hook of the tower crane based on the first image sensor dataset, the second image sensor dataset, a sensing-units calibration data and the distance between the first sensing unit and the second sensing unit, and
control operation of the tower crane at least based on the determined real-world geographic location data,
wherein the processing module is configured to:
determine a three-dimensional (3D) model of at least a portion of a construction site based on the first image sensor dataset and the second image sensor dataset, the 3D model comprising a set of data values that provide a 3D presentation of at least a portion of the construction site,
wherein real-world geographic locations of at least some of the data vales of the 3D model are known,
wherein the processing module is further configured to:
receive an origin point of interest in the construction site from which a cargo should be collected and a designation point of interest in the construction site to which the cargo should be delivered;
determine real-world geographic locations of the origin point of interest and the destination point of interest based on the 3D model; and
determine one or more routes between the origin point of interest and the destination point of interest based on the determined real-world geographic locations and the 3D model.

2. The system of claim 1, wherein the first sensing unit and the second sensing unit are multispectral sensing units each comprising at least two of: MWIR optical sensor, LWIR optical sensor, SWIR optical sensor, visible range optical sensor, LIDAR sensor, GPS sensor, one or more inertial sensors, anemometer, audio sensor and any combination thereof.

3. The system of claim 1, wherein the processing module is configured to determine the 3D model further based on a LIDAR dataset from at least one of the first sensing unit and the second sensing unit.

4. The system of claim 1, wherein the processing module is configured to:
generate a two-dimensional (2D) projection of the 3D model; and
display at least one of the generated 2D projection, the first image sensor dataset and the second image sensor dataset on a display.

5. The system of claim 4, wherein the processing module is configured to determine the 2D projection of the 3D model based on at least one of: an operator's inputs received using one or more input devices, a line-of-sight (LOS) of the operator tracked by a LOS tracker, and an external source.

6. The system of claim 5, wherein the processing module is configured to:
receive a selection of one or more points of interest made by an operator based on at least one of a 2D projection of the 3D model, the first image sensor dataset and the second image sensor dataset being displayed on a display; and
determine a real-world geographic location of the one or more points of interest based on a predetermined display-to-sensing-units coordinate systems transformation, a predetermined sensing-units-to-3D-model coordinate systems transformation and the 3D model.

7. The system of claim 1, wherein the processing module is configured to:
generate, based the one or more determined routes, operational instructions to be performed by the tower crane to complete a task; and
at least one of:
automatically control the tower crane based on the operational instructions and the real-world geographic location data;
display at least one of the one or more determined routes and the operational instructions to the operator and control the tower crane based on the operator's input commands.

8. The system of claim 1, wherein the processing module is configured to detect a collision hazard based on the first image sensor dataset, the second image sensor dataset, the determined real-world geographic location data and the 3D model.

9. The system of claim 8, wherein the processing module is configured to:
detect an object in the construction site in at least one of the first image sensor dataset and the second image sensor dataset;
determine a real-world geographic location of the detected object based on the 3D model;
determine whether there is a hazard of collision of at least one component of the tower crane and a cargo with the detected object based on the determined real-world geographic location of the detected object and the determined real-world geographic location data; and
at least one of:
issue a notification if a hazard of collision is detected; and
one of update and change the route upon detection of the collision hazard.

10. The system of claim 1, wherein the one or more points of interest comprising a safety zone to which a cargo being carried by the tower crane should be delivered in the case of failure of the system.

11. The system of claim 1, comprising:
an aerial platform configured to navigate in at least a portion of the construction site and generate aerial platform data values providing a 3D presentation of at least a portion of a construction site; and
wherein the processing module is configured to update the 3D model based on at least a portion of the aerial platform data values.

12. The system of claim 1, wherein the processing module is:
in communication with a database of preceding 3D models of the construction site or a portion thereof; and
configured to:
compare the determined 3D model with at least one of the preceding 3D models; and
present the comparison results indicative of a construction progress made to at least one of the operator and an authorized third party.

13. The system of claim 1, wherein the processing module is configured to:
generate a 2D graphics with respect to a display coordinate system; and
enhance at least one of the first image sensor data, the second image sensor data and a 2D projection of a 3D model being displayed on the display with the 2D graphics.

14. The system of claim 13, wherein the 2D graphics comprises visual presentation of at least one of: a jib of the tower crane, trolley position along the jib and jib's stoppers, an angular velocity of the jib, a jib direction with respect to North, a wind direction with respect to North, status of one or more input devices of the system, height of a hook above a ground, a relative panorama viewpoint, statistical process control, an operator card, a task bar and any combination thereof.

15. The system of claim 1, wherein the processing module is configured to:
generate a 3D graphics with respect to a real-world coordinate system; and
enhance at least one of the first image sensor data, the second image sensor data and a 2D projection of the 3D model being displayed on the display with the 3D graphics.

16. The system of claim 15, wherein the 3D graphics comprises visual presentation of at least one of: different zones in the construction site, weight zones, a tower crane maximal cylinder zone, a tower crane cylinder zone overlap with a tower crane cylinder zone of another crane, current cargo position and cargo drop position, a lift to drop route, a specified person on in the construction site, at least one of moving elements, velocity and estimated routes thereof, at least one of bulk material and the estimated amount thereof, hook turn direction, safety alerts and any combination thereof.

17. A method of a remote control of a tower crane, the method comprising:
obtaining a first image sensor dataset by a first image sensor a first sensing unit;
obtaining a second image sensor dataset by a second image sensor of a second sensing unit;
wherein the first sensing unit and the second sensing unit are disposed on a jib of a tower crane at a distance with respect to each other such that a field-of-view of the first sensing unit at least partly overlaps with a field-of-view of the second sensing unit;
determining, by a processing module, a real-world geographic location data indicative at least of a real-world geographic location of a hook of the tower crane based on the first image sensor dataset, the second image sensor dataset, a sensing-units calibration data and the distance between the first sensing unit and the second sensing unit;
controlling, by the processing module, operation of the tower crane at least based on the determined real-world geographic location data;
determining a three-dimensional (3D) model of at least a portion of a construction site based on the first image sensor dataset and the second image sensor dataset, the 3D model comprising a set of data values that provide a 3D presentation of at least a portion of the construction site,
wherein real-world geographic locations of at least some of the data vales of the 3D model are known;
receiving an origin point of interest in the construction site from which a cargo should be collected and a designation point of interest in the construction site to which the cargo should be delivered;
determining real-world geographic locations of the origin point of interest and the destination point of interest based on the 3D model; and
determining one or more routes between the origin point of interest and the destination point of interest based on the determined real-world geographic locations and the 3D model.

18. The method of claim 17, wherein the first sensing unit and the second sensing unit are multispectral sensing units each comprising at least two of: MWIR optical sensor, LWIR optical sensor, SWIR optical sensor, visible range optical sensor, LIDAR sensor, GPS sensor, one or more inertial sensors, anemometer, audio sensor and any combination thereof.

19. The method of claim 17, further comprising determining the 3D model further based on a LIDAR dataset from at least one of the first sensing unit and the second sensing unit.

20. The method of claim 17, further comprising:
generating a two-dimensional (2D) projection of the 3D model; and
displaying at least one of the generated 2D projection, the first image sensor dataset and the second image sensor dataset on a display.
